(19) United States
(12) Patent Application Publication
(10) Pub. No.: US 2026/0179557 A1
(43) Pub. Date: Jun. 25, 2026

(54) DISPLAY PANEL AND DISPLAY DEVICE INCLUDING THE SAME

(71) Applicant: LG DISPLAY CO., LTD., Seoul (KR)

(72) Inventors: Seunghwan SHIN, Jeonju-si (KR); Wonho LEE, Paju-si (KR)

(73) Assignee: LG DISPLAY CO., LTD., Seoul (KR)

(21) Appl. No.: 19/427,177

(22) Filed: Dec. 19, 2025

(30) Foreign Application Priority Data
Dec. 20, 2024 (KR) 10-2024-0192752

(51) Int. Cl. G09G 3/3233

(52) U.S. Cl. CPC G09G 3/3233; G09G 2300/0452; G09G 2300/0842; G09G 2310/08; G09G 2320/0233; G09G 2330/021; G09G 2330/045

(57) ABSTRACT

A display panel can include a plurality of pixels, each of the plurality of pixels including a plurality of sub-pixels configured to emit light of different colors, a plurality of data lines configured to supply a data voltage to the plurality of pixels, and a plurality of gate lines configured to supply a gate signal to the plurality of pixels. Also, each of the plurality of data lines divides into a plurality of bridge data lines, and a group of five sub-pixels among the plurality of pixels arranged in a same row are configured to be driven by two data lines among the plurality of data lines and emit light of a same color.

### CROSS REFERENCE TO RELATED APPLICATION

The present application claims priority to Korean Patent Application No. 10-2024-0192752, filed in the Republic of Korea on Dec. 20, 2024, the entire contents of which is incorporated herein for all purposes by this reference.

### BACKGROUND

### Field

The present disclosure relates to a display device, and more particularly, to a display panel in which a data line divides into a plurality of sub-data lines, and an additional high-potential voltage line is additionally disposed in addition to a plurality of high-potential voltage lines to extend in a direction perpendicular to an extension direction of each of the plurality of high-potential voltage lines, and a display device including the same.

### Description of the Related Art

Display devices used in a computer monitor, a TV, a mobile phone, or the like include an organic light-emitting display device (OLED) that emits light by itself, and a liquid crystal display device (LCD) that requires a separate light source.

Among these various display devices, the organic light-emitting display device includes a display panel including a plurality of sub-pixels and a driver for driving the display panel. The driver includes a gate driver for supplying a gate signal to the display panel and a data driver for supplying a data voltage. When a signal such as a gate signal and a data voltage is supplied to a sub-pixel of the organic light-emitting display device, the selected sub-pixel can emit light to display an image.

However, as the resolution of display panels increases, the complexity of the required internal circuitry also grows. This complexity can lead to significant design challenges that often result in visual inconsistencies or impairments, reduced power efficiency and increased manufacturing difficulties. For example, existing display architectures can suffer from compromised image quality and a shorter operational lifespan.

Thus, a need exists for an improved pixel architecture and driving methodology that mitigates these limitations. Further, there is a need for a display device having an improved configuration in which a data voltage is applied to multiple sub-pixels emitting light of the same color in a way that solves the complexity of the line arrangements and equalizes the aperture ratio.

### SUMMARY OF THE DISCLOSURE

The present disclosure has been made in view of the above problems and it is an object of the present disclosure to provide a display panel and a display device having an improved pixel structure that enhances image uniformity and power efficiency.

Accordingly, the inventors of the present disclosure have invented a display panel in which a data voltage is applied to each of the sub-pixels emitting light of the same color via each sub-data line to solve the complexity of the line arrangement and equalize the aperture ratio.

A technical purpose to be achieved according to an embodiment of the present disclosure is to provide a display panel in which a data line divides into a plurality of sub-data lines and a data voltage is applied to one sub-pixel via each sub-data line.

In addition, a technical purpose to be achieved according to an embodiment of the present disclosure is to provide a display panel in which a single additional high potential voltage line is disposed every five gate lines among the plurality of gate lines, in which the plurality of high potential voltage lines and the additional high potential voltage lines intersect each other to form a mesh structure.

In addition, a technical purpose to be achieved according to an embodiment of the present disclosure is to provide a display panel in which each of the plurality of data lines divides into three sub-data lines such that the data voltage is applied to each of three sub-pixels emitting light of the same color arranged in the first row via each of the three sub-data lines, or each of the plurality of data lines divides into two sub-data lines such that the data voltage is applied to each of two sub-pixels emitting light of the same color arranged in the first row via each of the two sub-data lines.

Purposes according to the present disclosure are not limited to the above-mentioned purpose. Other purposes and advantages according to the present disclosure that are not mentioned can be understood based on following descriptions, and can be more clearly understood based on embodiments according to the present disclosure. Further, it will be easily understood that the purposes and advantages according to the present disclosure can be realized using means shown in the claims or combinations thereof.

A display device according to an embodiment of the present disclosure provides a display panel in which each of a plurality of data lines divides into a plurality of sub-data lines and the data voltage is applied to one sub-pixel via each sub-data line.

In addition, according to an embodiment of the present disclosure, there is provided a display panel for driving five pixels arranged in the same row using two data lines.

In addition, according to an embodiment of the present disclosure, a display panel is provided which includes a plurality of high potential voltage lines, each of the plurality of high potential voltage lines being disposed between adjacent pixels, in which the high potential voltage line extends in the column direction of the display panel, and each of the plurality of high potential voltage lines supplies a high potential voltage to the sub-pixels of each of the plurality of pixels.

In addition, according to an embodiment of the present disclosure, the display panel further comprises an additional high-potential voltage line extending in the row direction.

In addition, according to an embodiment of the present disclosure, a single additional high potential voltage line is disposed every five gate lines among the plurality of gate lines, in which the plurality of high potential voltage lines and the additional high potential voltage lines intersect each other to form a mesh structure.

In addition, according to an embodiment of the present disclosure, provided is a display panel in which the plurality of pixels include a first pixel to a fifth pixel sequentially arranged in the row direction, and the sub-pixels of each of the first pixel to the fifth pixel include a first sub-pixel to a fourth sub-pixel sequentially arranged in the row direction, in which each of the sub-pixels includes a light-emitting area and a driving circuit for driving the light-emitting area, and in each of the sub-pixels of each of the first pixel to the third pixel arranged in a first row, the driving circuit is disposed on the other of both opposing side in the column direction of the light-emitting area.

In addition, according to an embodiment of the present disclosure, in each of some of the sub-pixels of each of the fourth pixel and the fifth pixel arranged in the first row, the driving circuit is disposed on the other of both opposing side in the column direction of the light-emitting area, while in each of the others of the sub-pixels of each of the fourth pixel and the fifth pixel arranged in the first row, the driving circuit is disposed on one of both opposing side in the column direction of the light-emitting area.

In addition, according to an embodiment of the present disclosure, in each of the sub-pixels of each of the first pixel to the third pixel arranged in a second row, the driving circuit is disposed on one of both opposing sides in the column direction of the light-emitting area.

In addition, according to an embodiment of the present disclosure, in each of some of the sub-pixels of each of the fourth pixel and the fifth pixel arranged in the first row, the driving circuit is disposed on one of both opposing sides in the column direction of the light-emitting area, while in each of the others of the sub-pixels of each of the fourth pixel and the fifth pixel arranged in the first row, the driving circuit is disposed on the other one of the both opposing sides in the column direction of the light-emitting area.

According to an embodiment of the present disclosure, each of the plurality of data lines divides into the plurality of sub-data line, and one sub-data line can be connected to one sub-pixel to apply the data voltage thereto.

In addition, according to an embodiment of the present disclosure, a data voltage is applied to one sub-pixel via each sub-data line, thereby lowering a sensing voltage and reducing a sensing time.

In addition, according to an embodiment of the present disclosure, the additional high potential voltage line is disposed to extend in a direction perpendicular to the extension direction of the plurality of high potential voltage lines, such that the aperture ratio can be equalized and the luminance difference of some pixels can be reduced.

In addition, in the display device according to an embodiment of the present disclosure, 10 sub-pixels arranged in two rows can be driven using two data lines, such that the number of sub-data lines in the display panel can be reduced, and thus heat generation can be reduced and power consumed in the display device can be reduced.

In addition, in the display panel according to an embodiment of the present disclosure, each of the plurality of data lines divides into the plurality of sub-data lines, and one sub-data line is connected to one sub-pixel to apply the data voltage thereto, thereby solving a heating problem and reducing power consumption due to heating.

Effects of the present disclosure are not limited to the effects mentioned above, and other effects not mentioned will be clearly understood by those skilled in the art from the description as set forth below.

In addition to the above effects, specific effects of the present disclosure are described together while describing specific details for carrying out the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 is a schematic diagram of a display device according to an embodiment of the present disclosure.

FIG. 2 is a circuit diagram of a sub-pixel of a display device according to an embodiment of the present disclosure.

FIG. 3 is an example diagram illustrating a state in which a data line divides into sub-data lines in a display device according to an embodiment of the present disclosure.

FIG. 4 is an example diagram illustrating an arrangement relationship of sub-pixels of a display device according to an embodiment of the present disclosure.

FIG. 5 is a timing diagram of a gate voltage and a data voltage when a display device displays a monochromatic still screen according to an embodiment of the present disclosure.

FIG. 6 is a timing diagram of a gate voltage and a data voltage when a display device displays a vertical pattern screen according to an embodiment of the present disclosure.

FIG. 7 is an example diagram illustrating a connection relationship between sub-pixels emitting light of the same color, a gate line and sub-data lines in order to drive five pixels using two sub-data lines in a display device according to an embodiment of the present disclosure.

FIG. 8 is an example diagram illustrating an arrangement relationship of sub-pixels operating using two sub-data lines in a display device according to an embodiment of the present disclosure.

FIG. 9 is an example diagram illustrating a light emission state of a sub-pixel in a state in which a first gate voltage and a second gate voltage at a turn-on level are applied via a first gate line and a second gate line, respectively according to an embodiment of the present disclosure.

FIG. 10 is an example diagram illustrating a light emission state of a sub-pixel in a state in which a third gate voltage and a fourth gate voltage at a turn-on level are applied via a third gate line and a fourth gate line, respectively according to an embodiment of the present disclosure.

FIG. 11 is an example diagram illustrating a light emission state of a sub-pixel in a state in which a fifth gate voltage at a turn-on level is applied via a fifth gate line according to an embodiment of the present disclosure.

FIG. 12 is an example diagram illustrating an operation order of a pixel according to an embodiment of the present disclosure.

FIG. 13 is a timing diagram of a gate voltage and a data voltage when a display device displays a monochromatic still screen according to an embodiment of the present disclosure.

FIG. 14 is an example diagram illustrating a state in which each of a plurality of data lines divides into a plurality of sub-data lines and each of the sub-data lines is connected to one sub-pixel in a display panel according to an embodiment of the present disclosure.

FIG. 15 is an example diagram illustrating a state in which each of a first data line and a second data line divides into a plurality of sub-data lines and each of the sub-data lines is connected to a first sub-pixel of each pixel in a display panel according to an embodiment of the present disclosure.

FIG. 16 is an example diagram illustrating a driving scheme of a first sub-pixel using the plurality of sub-data lines into which the first data line divides according to FIG. 15 according to an embodiment of the present disclosure.

FIG. 17 is an example diagram illustrating a state in which each of a first data line and a second data line divides into a plurality of sub-data lines and each of the sub-data lines is connected to a second sub-pixel of each pixel in a display panel according to an embodiment of the present disclosure.

FIG. 18 is an example diagram illustrating a driving scheme of a second sub-pixel using the plurality of sub-data lines into which the first data line divides according to FIG. 17 according to an embodiment of the present disclosure.

FIG. 19 is an example diagram illustrating a state in which each of a first data line and a second data line divides into a plurality of sub-data lines and each of the sub-data lines is connected to a third sub-pixel of each pixel in a display panel according to an embodiment of the present disclosure.

FIG. 20 is an example diagram illustrating a driving scheme of a third sub-pixel using the plurality of sub-data lines into which the first data line divides according to FIG. 19 according to an embodiment of the present disclosure.

FIG. 21 is an example diagram illustrating a state in which each of a first data line and a second data line divides into a plurality of sub-data lines and each of the sub-data lines is connected to a fourth sub-pixel of each pixel in a display panel according to an embodiment of the present disclosure.

FIG. 22 is an example diagram illustrating a driving scheme of a fourth sub-pixel using the plurality of sub-data lines into which the first data line divides according to FIG. 21 according to an embodiment of the present disclosure.

FIG. 23 is a result showing sensing characteristics based on a reference voltage in a related art example.

FIG. 24 is a result showing sensing characteristics based on a reference voltage according to an embodiment of the present disclosure.

### DETAILED DESCRIPTION OF THE EMBODIMENTS

Advantages and features of the present disclosure, and a method of achieving the advantages and features will become apparent with reference to embodiments described below in detail together with the accompanying drawings. However, the present disclosure is not limited to the embodiments as disclosed under, but can be implemented in various different forms. Thus, these embodiments are set forth only to make the present disclosure complete, and to entirely inform the scope of the present disclosure to those of ordinary skill in the technical field to which the present disclosure belongs, and the present disclosure is only defined by the scope of the claims.

For simplicity and clarity of illustration, elements in the drawings are not necessarily drawn to scale. The same reference numbers in different drawings represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure can be practiced without these specific details. In other instances, well-known methods, procedures, components, and circuits have not been described in detail so as not to unnecessarily obscure aspects of the present disclosure. Examples of various embodiments are illustrated and described further below. It will be understood that the description herein is not intended to limit the claims to the specific embodiments described. On the contrary, it is intended to cover alternatives, modifications, and equivalents as can be included within the spirit and scope of the present disclosure as defined by the appended claims.

A shape, a size, a ratio, an angle, a number, etc. disclosed in the drawings for illustrating embodiments of the present disclosure are illustrative, and the present disclosure is not limited thereto. The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise. It will be further understood that the terms “comprise,” “comprising,” “include,” and “including” when used in this disclosure, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of associated listed items. Expression such as “at least one of” when preceding a list of elements can modify an entirety of the list of elements and may not modify the individual elements of the list.

In interpretation of numerical values, an error or tolerance therein can occur even when there is no explicit description thereof.

In addition, it will also be understood that when a first element or layer is referred to as being present “on” a second element or layer, the first element can be disposed directly on the second element or can be disposed indirectly on the second element with a third element or layer being disposed between the first and second elements or layers. It will be understood that when a first element or layer is referred to as being “connected to,” or “coupled to” a second element or layer, the first element can be directly connected to or coupled to the second element or layer, or one or more intervening elements or layers can be present therebetween. In addition, it will also be understood that when an element or layer is referred to as being “between” two elements or layers, it can be the only element or layer between the two elements or layers, or one or more intervening elements or layers can also be present therebetween.

Further, as used herein, when a layer, film, area, plate, or the like is disposed “on” or “on a top” of another layer, film, area, plate, or the like, the former can directly contact the latter or still another layer, film, area, plate, or the like can be disposed between the former and the latter. As used herein, when a layer, film, area, plate, or the like is directly disposed “on” or “on a top” of another layer, film, area, plate, or the like, the former directly contacts the latter and still another layer, film, area, plate, or the like is not disposed between the former and the latter. Further, as used herein, when a layer, film, area, plate, or the like is disposed “below” or “under” another layer, film, area, plate, or the like, the former can directly contact the latter or still another layer, film, area, plate, or the like can be disposed between the former and the latter. As used herein, when a layer, film, area, plate, or the like is directly disposed “below” or “under” another layer, film, area, plate, or the like, the former directly contacts the latter and still another layer, film, area, plate, or the like is not disposed between the former and the latter.

In descriptions of temporal relationships, for example, temporal precedent relationships between two events such as “after,” “subsequent to,” “before,” etc., another event can occur therebetween unless “directly after,” “directly subsequent” or “directly before” is not indicated. When a certain embodiment can be implemented differently, a function or an operation specified in a specific block can occur in a different order from an order specified in a flowchart. For example, two blocks in succession can be actually performed substantially concurrently, or the two blocks can be performed in a reverse order depending on a function or operation involved.

It will be understood that, although the terms “first,” “second,” “third,” and so on can be used herein to describe various elements, components, areas, layers and/or periods, these elements, components, areas, layers and/or periods should not be limited by these terms. These terms are used to distinguish one element, component, area, layer or section from another element, component, area, layer or section. Thus, a first element, component, area, layer or section as described under could be termed a second element, component, area, layer or section, without departing from the spirit and scope of the present disclosure.

When an embodiment can be implemented differently, functions or operations specified within a specific block can be performed in a different order from an order specified in a flowchart. For example, two consecutive blocks can actually be performed substantially simultaneously, or the blocks can be performed in a reverse order depending on related functions or operations.

The features of the various embodiments of the present disclosure can be partially or entirely combined with each other, and can be technically associated with each other or operate with each other. The embodiments can be implemented independently of each other and can be implemented together in an association relationship. Also, the term “can” used herein includes all meanings and definitions of the term “may.”

In interpreting a numerical value, the value is interpreted as including an error range unless there is no separate explicit description thereof. Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, “embodiments,” “examples,” “aspects, etc. should not be construed such that any aspect or design as described is superior to or advantageous over other aspects or designs. Further, the term ‘or’ means ‘inclusive or’ rather than ‘exclusive or.’ That is, unless otherwise stated or clear from the context, the expression that ‘x uses a or b’ means one of natural inclusive permutations.

The terms used in the description as set forth below have been selected as being general and universal in the related technical field. However, there can be other terms than the terms depending on the development and/or change of technology, convention, preference of technicians, etc. Therefore, the terms used in the description as set forth below should not be understood as limiting technical ideas, but should be understood as examples of the terms for illustrating embodiments. Further, in a specific situation, a term can be arbitrarily selected by the applicant, and in this situation, the detailed meaning thereof will be described in a corresponding description period. Therefore, the terms used in the description as set forth below should be understood based on not simply the name of the terms, but the meaning of the terms and the contents throughout the Detailed Descriptions.

In description of flow of a signal, for example, when a signal is delivered from a node A to a node B, this can include a situation where the signal is transferred from the node A to the node B via another node unless a phrase “immediately transferred” or “directly transferred” is used. Throughout the present disclosure, “A and/or B” means A, B, or A and B, unless otherwise specified, and “C to D” means C inclusive to D inclusive unless otherwise specified.

As used herein, a first direction, a second direction, and a third direction, or an X-axis direction, a Y-axis direction, and a Z-axis direction should not be interpreted only as having a geometric relationship with each other in which the first direction, the second direction, and the third direction are perpendicular to each other or the X-axis direction, the Y-axis direction, and the Z-axis direction are perpendicular to each other, but can be interpreted as having a geometric relationship with each other in which the first direction, the second direction, and the third direction interest each other at an angle other than 90 degrees or the X-axis direction, the Y-axis direction, and the Z-axis direction are interest each other at an angle other than 90 degrees within a range in which a configuration of the present disclosure can work functionally. In a plan view of the display device, a column direction and a row direction intersecting each other are used to define an extension direction of a component, for example, a line.

Hereinafter, various embodiments of the present disclosure will be described in detail with reference to the accompanying drawings.

A transistor used in the display device of the present disclosure can be embodied as one or more transistors of an n-channel transistor NMOS and a p-channel transistor PMOS. The transistor can be embodied as an oxide semiconductor transistor having an oxide semiconductor layer as an active layer or an LTPS transistor having a low temperature poly-silicon (LTPS) layer as an active layer. The transistor can include at least a gate electrode, a source electrode, and a drain electrode. The transistor can be embodied as a thin-film transistor (TFT) on the display panel. The carriers in the transistor flow from the source electrode to the drain electrode. In the n-channel transistor NMOS, since the carriers are electrons, the source voltage is lower than the drain voltage so that electrons can flow from the source electrode to the drain electrode. In the n-channel transistor NMOS, the current flows from the drain electrode to the source electrode, and the source electrode can be an output terminal. In the p-channel transistor PMOS, since the carrier is a hole, the source voltage is higher than the drain voltage so that the hole can flow from the source electrode to the drain electrode. In the p-channel transistor PMOS, since holes flow from the source electrode to the drain electrode, a current flows from the source electrode to the drain electrode, and the drain electrode can be an output terminal. Therefore, it should be noted that the source and the drain of the transistor are not fixed because the source and the drain can be exchanged with each other based on the applied voltage. In the present disclosure, it is assumed that the transistor is an n-channel transistor (NMOS). However, embodiments of the present disclosure are not limited thereto, and the transistor can be embodied as an p-channel transistor, and accordingly, a circuit configuration can be changed.

A gate signal of a transistor used as each of switch elements swings between a gate-on voltage and a gate-off voltage. The gate-on voltage is set to a voltage higher than the threshold voltage Vth of the transistor, and the gate-off voltage is set to a voltage lower than the threshold voltage Vth of the transistor. The transistor is turned on in response to the gate-on voltage VGL, while being turned off in response to the gate-off voltage VGL. In the NMOS, the gate-on voltage can be the gate high voltage VGH, and the gate-off voltage can be the gate low voltage VGL. In the PMOS, the gate-on voltage can be the gate low voltage VGL, and the gate-off voltage can be the gate high voltage VGH.

Hereinafter, various embodiments of the present disclosure will be described in detail with reference to the accompanying drawings.

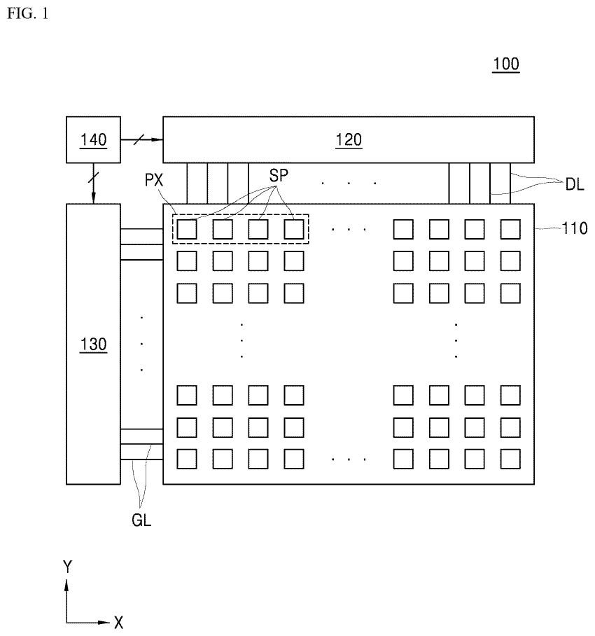

FIG. 1 is a schematic diagram of a display device according to an embodiment of the present disclosure.

Referring to FIG. 1, a display device 100 according to an embodiment of the present disclosure can include a display panel 110, a data driver 120, a gate driver 130, and a timing controller 140.

The configuration of the display panel 110 illustrated in FIG. 1 is merely according to an embodiment, and the components of the display panel 110 are not limited to those in the embodiment as illustrated in FIG. 1, and some components can be added, changed, or deleted as necessary.

According to an embodiment, the display panel 110 is a panel for displaying an image. The display panel 110 can include various circuits, lines, and light-emitting elements disposed on a substrate. An area of the display panel 110 can divide into pixels areas defined by a plurality of data lines DL and a plurality of gate lines GL intersecting each other, and can include a plurality of pixels PX respectively disposed in the pixel areas and connected to the plurality of data lines DL and the plurality of gate lines GL.

The display panel 110 can include a display area including the plurality of pixels PX and a non-display area in which various signal lines or pads are formed.

The display panel 110 can be embodied as a display panel 110 used in various display devices such as a liquid crystal display device, an organic light-emitting display device, an electrophoretic display device, and the like.

Hereinafter, an example is described in which the display panel 110 is a panel used in an organic light-emitting display device. However, embodiments of the present disclosure are not limited thereto.

According to an embodiment, the timing controller 140 can receive a timing signal such as a vertical synchronization signal, a horizontal synchronization signal, a data enable signal, and a dot clock via a receiving circuit such as an LVDS or TMDS interface connected to a host system. The timing controller 140 can generate timing control signals for controlling the data driver 120 and the gate driver 130 based on the input timing signal.

According to an embodiment, the data driver 120 can supply a data voltage DATA to the plurality of sub-pixels SP. The data driver 120 can include a plurality of source drive integrated circuits (IC). The plurality of source drive IC can receive digital video data and a source timing control signal from the timing controller 140.

The plurality of source drive ICs can convert the digital video data into a gamma voltage in response to the source timing control signal to generate the data voltage DATA, and can supply the data voltage DATA via the data line DL of the display panel 110. The plurality of source drive ICs can be connected to the data line DL of the display panel 110 in a chip on glass (COG) process or a tape automated bonding (TAB) process.

In addition, the source drive ICs can be formed on the display panel 110, or can be formed on a separate PCB substrate which can be connected to the display panel 110.

According to an embodiment, the gate driver 130 can supply a gate signal to the plurality of sub-pixels SP. The gate driver 130 can include a level shifter and a shift register. The level shifter can shift a level of a clock signal input from the timing controller 140 to a transistor-transistor-logic (TTL) level and then supply the signal having the shifted level to the shift register. The shift register can be formed in the non-display area of the display panel 110 in an GIP (gate in panel) manner. However, embodiments of the present disclosure are not limited thereto.

The shift register can include a plurality of stages that shift and output the gate signal in response to the clock signal and a driving signal. The plurality of stages included in the shift register can sequentially output the gate signal via a plurality of output terminals.

According to an embodiment, the display panel 110 can include a plurality of sub-pixels SP. The plurality of sub-pixels SP can be sub-pixels SP for emitting light of different colors. For example, the plurality of sub-pixels SP can include a red sub-pixel, a green sub-pixel, a blue sub-pixel, and a white sub-pixel. However, embodiments of the present disclosure are not limited thereto. The plurality of sub-pixels SP can constitute the pixel PX.

That is, the red sub pixel, the green sub pixel, the blue sub pixel, and the white sub pixel can constitute a single pixel PX, and the display panel 110 can include a plurality of pixels PX.

In one example, a first pixel of the display panel 110 can include a plurality of sub-pixels, and a second pixel thereof can include a plurality of sub-pixels. In addition, the second pixel can be disposed at a position adjacent to the first pixel in the first direction (e.g., the x-axis direction). Furthermore, a second sub-pixel of the first pixel can be disposed at a position adjacent to a first sub-pixel of the first pixel in the first direction (e.g., the x-axis direction). In addition, a third sub-pixel of the first pixel can be disposed at a position adjacent to the second sub-pixel of the first pixel in the first direction (e.g., the x-axis direction). Furthermore, a second sub-pixel of the second pixel can be disposed at a position adjacent to a first sub-pixel of the second pixel in the first direction (e.g., the x-axis direction). In addition, a third sub-pixel of the second pixel can be disposed at a position adjacent to the second sub-pixel of the second pixel in the first direction (e.g., the x-axis direction).

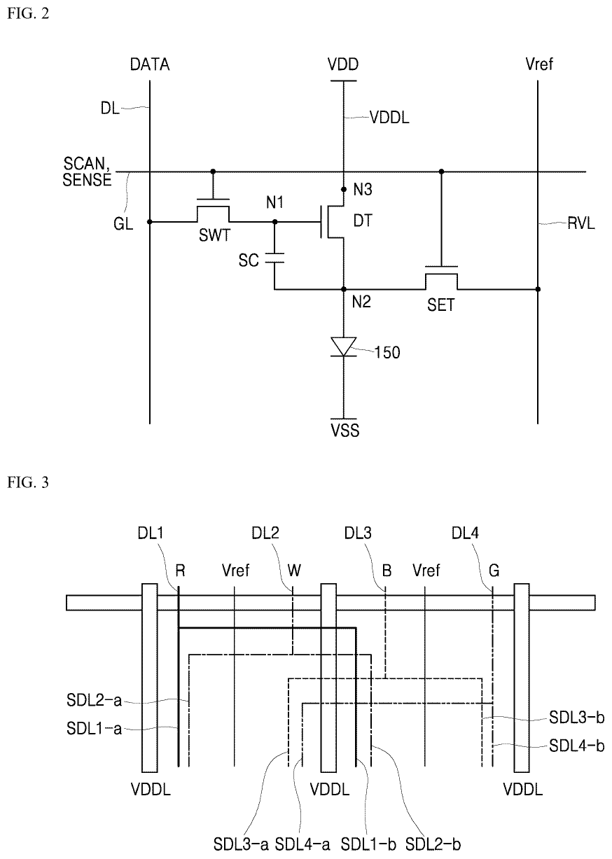

Hereinafter, for a more detailed description of a driving circuit for driving one sub-pixel SP, FIG. 2 will be referred to together with FIG. 1.

FIG. 2 is a circuit diagram of a sub-pixel of a display device according to an embodiment of the present disclosure.

FIG. 2 illustrates a circuit diagram of one sub-pixel SP among the plurality of sub-pixels SP of the display device 100.

Referring to FIG. 2, the sub-pixel SP can include a switching transistor SWT, a sensing transistor SET, a driving transistor DT, a storage capacitor SC, and a light-emitting element 150.

According to an embodiment, the light-emitting element 150 can include an anode, an organic layer stack, and a cathode. The organic layer stack can include a stack of various organic layers such as a hole injection layer, a hole transport layer, an organic light-emitting layer, an electron transport layer, and an electron injection layer. The anode of the light-emitting element 150 can be connected to an output terminal of the driving transistor DT, and a low potential voltage VSS can be applied to the cathode of the light-emitting element 150.

Although FIG. 2 illustrates that the light-emitting element 150 is embodied as the organic light-emitting element 150, the present disclosure is not limited thereto, and an inorganic light-emitting diode, that is, LED, can also be used as the light-emitting element 150.

Referring to FIG. 2, the switching transistor SWT is a transistor for transferring the data voltage DATA to a first node N1 connected to a gate electrode of the driving transistor DT. The switching transistor SWT can include a drain electrode connected to the data line DL, a gate electrode connected to the gate line GL, and a source electrode connected to the gate electrode of the driving transistor DT. The switching transistor SWT can be turned on based on a gate voltage GATE applied from the gate line GL to transmit the data voltage DATA supplied from the data line DL to the first node N1 connected to the gate electrode of the driving transistor DT.

Referring to FIG. 2, the driving transistor DT is a transistor for driving the light-emitting element 150 by supplying a driving current to the light-emitting element 150. The driving transistor DT can include a gate electrode connected to the first node N1, a source electrode connected to a second node N2 and corresponding to an output terminal, and a drain electrode connected to a third node N3 and corresponding to an input terminal.

The gate electrode of the driving transistor DT can be connected to the switching transistor SWT, a drain electrode thereof can receive a high potential voltage VDD via a high potential voltage line VDDL, and a source electrode thereof can be connected to the anode of the light-emitting element 150.

Referring to FIG. 2, the storage capacitor SC is a capacitor for maintaining a voltage corresponding to the data voltage DATA for one frame. One electrode of the storage capacitor SC can be connected to the first node N1, and the other electrode thereof can be connected to the second node N2.

In one example, in the display device 100, as an operation time of each sub-pixel SP increases, degradation of a circuit element such as the driving transistor DT can proceed. Accordingly, an intrinsic characteristic value of the circuit element such as the driving transistor DT can be changed.

In this regard, the intrinsic characteristic value of the circuit element can include the threshold voltage Vth of the driving transistor DT, the mobility α of the driving transistor DT, etc. The change in the intrinsic characteristic value of the circuit element can cause a change in luminance of the corresponding sub-pixel SP.

Therefore, the change in the intrinsic characteristic value of the circuit element can be used as the same concept as the change in the luminance of the sub-pixel SP.

In addition, the change amount in the intrinsic characteristic value of the circuit element of each sub-pixel SP can vary depending on the deterioration amount of each circuit element. Thus, the change amounts in the intrinsic characteristic value of the circuit elements of different sub-pixels SP having the different deterioration amounts of the circuit elements thereof can be different from each other. Such a difference between the change amounts in the intrinsic characteristic value of the respective circuit elements of the sub-pixels can cause a luminance deviation between luminance of the sub-pixels SP.

Therefore, the deviation between the intrinsic characteristic value of the circuit elements of the different sub-pixels SP can be used as the same concept as the luminance deviation between the luminance of the different sub-pixels SP.

The change in the intrinsic characteristic value of the circuit element, that is, the change in the luminance of the sub-pixel SP and the deviations between in the intrinsic characteristic values of the circuit elements of the sub-pixels, that is, the deviation between the luminance of the sub-pixels SP, can cause problems such as a decrease in accuracy of the luminance realized in the sub-pixel SP or a screen abnormality.

Accordingly, in the sub-pixel SP of the display device 100 according to an embodiment of the present disclosure, a sensing function of sensing the intrinsic characteristic value of the sub-pixel SP and a compensation function of compensating for the intrinsic characteristic value of the sub-pixel SP based on the sensing result can be provided.

Accordingly, as shown in FIG. 2, the sub-pixel SP can further include a sensing transistor SET for effectively controlling the voltage state of the source electrode of the driving transistor DT in addition to the switching transistor SWT, the driving transistor DT, the storage capacitor SC, and the light-emitting element 150.

Referring to FIG. 2, the sensing transistor SET is connected to and disposed between the source electrode of the driving transistor DT and a reference voltage line RVL that supplies a reference voltage Vref. A gate electrode of the sensing transistor SET is connected to the gate line GL. Accordingly, the sensing transistor SET can be turned on based on the sensing signal SENSE applied via the gate line GL to apply the reference voltage Vref supplied via the reference voltage line RVL to the source electrode of the driving transistor DT. In addition, the sensing transistor SET can be used as one of voltage sensing paths for the source electrode of the driving transistor DT.

Referring to FIG. 2, the switching transistor SWT and the sensing transistor SET of the sub-pixel SP can share one gate line GL. That is, the switching transistor SWT and the sensing transistor SET can be connected to the same gate line GL and can receive the same gate signal therefrom. However, for convenience of description, a voltage applied to the gate electrode of the switching transistor SWT is referred to as the gate voltage GATE, and a voltage applied to the gate electrode of the sensing transistor SET is referred to as a sensing signal SENSE. However, the gate voltage GATE and the sensing signal SENSE applied to one sub-pixel SP are the same signal transmitted via the same gate line GL.

However, the present disclosure is not limited thereto, and only the switching transistor SWT can be connected to the gate line GL, and the sensing transistor SET can be connected to a separate sensing line. Accordingly, the gate voltage GATE can be applied to the switching transistor SWT via the gate line GL, and the sensing signal SENSE can be applied to the sensing transistor SET via the sensing line.

Accordingly, the reference voltage Vref is applied to the source electrode of the driving transistor DT via the sensing transistor SET. In addition, a voltage for sensing the threshold voltage Vth of the driving transistor DT or the mobility α of the driving transistor DT is detected via the reference voltage line RVL. In addition, the data driver 120 can compensate for the data voltage DATA based on an amount of change in the detected threshold voltage Vth of the driving transistor DT or the detected mobility α of the driving transistor DT.

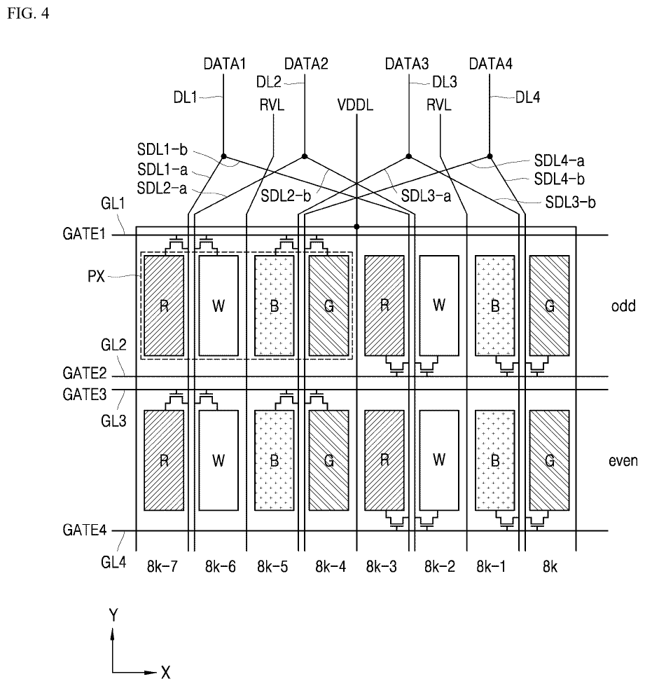

Hereinafter, FIGS. 3 and 4 are referred together to describe an arrangement relationship of a plurality of sub-pixels according to an embodiment of the present disclosure.

FIG. 3 is an example diagram illustrating a state in which a data line divides into sub-data lines in a display device according to an embodiment of the present disclosure. FIG. 4 is an example diagram illustrating an arrangement relationship of sub-pixels of a display device according to an embodiment of the present disclosure.

For convenience of description, only four pixels PX arranged in a 2×2 matrix form are illustrated in FIGS. 3 and 4. An arrangement relationship of four pixels PX arranged in a 2×2 matrix form can be repeated in the display area DA. In addition, a transistor disposed between the sub-pixels R, G, B, and W and the data line means the switching transistor SWT described in FIG. 2.

According to an embodiment, each of the plurality of data lines DL1, DL2, DL3, and DL4 can divide into a plurality of sub-data lines SDL1-a and SDL1-b, SDL2-a and SDL2-b, SDL3-a and SDL3-b, or SDL4-a and SDL4-b.

Specifically, the first data line DL1 can divide into a plurality of first sub-data lines SDL1-a and SDL1-b, and the second data line DL2 can divide into a plurality of second sub-data lines SDL2-a and SDL2-b.

The third data line DL3 can divide into the plurality of third sub-data lines SDL3-a and SDL3-b, and the fourth data line DL4 can divide into the plurality of fourth sub-data lines SDL4-a and SDL4-b .

According to an embodiment, the first sub-data lines SDL1-a and SDL1-b can include a (1-a)th sub-data line SDL1-a and a (1-b)th sub-data line SDL1-b, and the second sub-data lines SDL2-a and SDL2-b can include a (2-a)th sub-data line SDL2-a and a (2-b)th sub-data line SDL2-b.

The third sub-data lines SDL3-a and SDL3-b can include a (3-a)th sub-data line SDL3-a and a (3-b)th sub-data line SDL3-b, and the fourth sub-data lines SDL4-a and SDL4-b can include a (4-a)th sub-data line SDL4-a and a (4-b)th sub-data line SDL4-b.

Each of the plurality of high potential voltage lines VDDL can be disposed between adjacent ones of the plurality of pixels PX.

According to an embodiment, one pixel PX (e.g., a unit pixel) can include four sub-pixels R, G, B, and W. For example, as shown in FIG. 4, the pixel PX can include a first sub-pixel R, a second sub-pixel W, a third sub-pixel B, and a fourth sub-pixel G. For example, the first sub-pixel R can be a red sub-pixel, the second sub-pixel W can be a white sub-pixel, the third sub-pixel B can be a blue sub-pixel, and the fourth sub-pixel G can be a green sub-pixel. However, the present disclosure is not limited thereto, and the plurality of sub-pixels can include sub-pixels emitting light of various colors magenta, yellow, and cyan.

According to an embodiment, the second sub-pixel W of the first pixel can be disposed at a position adjacent to the first sub-pixel R of the first pixel in the first direction (e.g., the x-axis direction). In addition, the third sub-pixel B of the first pixel can be disposed at a position adjacent to the second sub-pixel W of the first pixel in the first direction (e.g., the x-axis direction). In addition, the fourth sub-pixel G of the first pixel can be disposed at a position adjacent to the third sub-pixel B of the first pixel in the first direction (e.g., the x-axis direction).

In addition, the plurality of sub-pixels emitting light of the same color can be arranged in the same column. That is, the plurality of first sub-pixels R can be arranged in the same column, the plurality of second sub-pixels W can be arranged in the same column, the plurality of third sub-pixels B can be arranged in the same column, and the plurality of fourth sub-pixels G can be arranged in the same column.

More specifically, as illustrated in FIG. 4, the plurality of first sub-pixels R can be arranged in a (8k−7)th column and a (8k−3)th column, and the plurality of second sub-pixels W can be arranged in a (8k−6)th column and a (8k−2)th column. In addition, the plurality of third sub-pixels B can be arranged in a (8k−5)th column and a (8k−1)th column, and the plurality of fourth sub-pixels G can be arranged in a (8k−4)th column and a 8k-th column. However, k means a natural number greater than or equal to 1.

That is, the first sub-pixel R, the second sub-pixel W, the third sub-pixel B, and the fourth sub-pixel G can be sequentially and repeatedly arranged along one odd row or one even row even.

According to an embodiment, each of the plurality of first sub-data lines SDL1-a and SDL1-b can be disposed adjacent to the plurality of first sub-pixels R and be respectively connected to the plurality of first sub-pixels R.

Specifically, the (1-a)th sub-data line SDL1-a can be disposed between the plurality of first sub-pixels R arranged in a (8k−7)th column and the plurality of second sub-pixels W arranged in a (8k−6)th column, and can be electrically connected to the plurality of first sub-pixels R arranged in the (8k−7)th column. In addition, the (1-b)th sub-data line SDL1-b can be disposed between the plurality of first sub-pixels R arranged in a (8k−3)th column and the plurality of second sub-pixels W arranged in a (8k−2)th column, and can be electrically connected to the plurality of first sub-pixels R arranged in the (8k−3)th column.

According to an embodiment, each of the plurality of second sub-data lines SDL2-a and SDL2-b can be disposed adjacent to the plurality of second sub-pixels W and can be connected to the plurality of second sub-pixels W.

Specifically, the (2-a)th sub-data line SDL2-a can be disposed between the plurality of first sub-pixels R arranged in a (8k−7)th column and the plurality of second sub-pixels W arranged in a (8k−6)th column, and can be electrically connected to the plurality of second sub-pixels W arranged in the (8k−6)th column. In addition, the (2-b)th sub-data line SDL2-b can be disposed between the plurality of first sub-pixels R arranged in a (8k−3)th column and the plurality of second sub-pixels W arranged in a (8k−2)th column and be electrically connected to the plurality of second sub-pixels W arranged in the (8k−2)th column.

According to an embodiment, each of the plurality of third sub-data lines SDL3-a and SDL3-b can be disposed adjacent to the plurality of third sub-pixels B and can be connected to the plurality of third sub-pixels B.

Specifically, the (3-a)th sub-data line SDL3-a can be disposed between the plurality of third sub-pixels B arranged in a (8k−5)th column and the plurality of fourth sub-pixels G arranged in a (8k−4)th column, and can be electrically connected to the plurality of third sub-pixels B arranged in the (8k−5)th column. In addition, the (3-b)th sub-data line SDL3-b can be disposed between the plurality of third sub-pixels B arranged in a (8k−1)th column and the plurality of fourth sub-pixels G arranged in a 8k-th column, and can be electrically connected to the plurality of third sub-pixels B arranged in the (8k−1)th column.

According to an embodiment, each of the plurality of fourth sub-data lines SDL4-a and SDL4-W can be disposed adjacent to the plurality of fourth sub-pixels G and can be connected to the plurality of fourth sub-pixels G.

Specifically, the (4-a)th sub-data line SDL4-a can be disposed between the plurality of third sub-pixels B arranged in a (8k−5)th column and the plurality of fourth sub-pixels G arranged in a (8k−4)th column, and can be electrically connected to the plurality of fourth sub-pixels G arranged in the (8k−4)th column. The (4-b)th sub-data lines SDL4-b can be disposed between the plurality of third sub-pixels B arranged in a (8k−1)th column and the plurality of fourth sub-pixels G arranged in a 8k-th column, and can be electrically connected to the plurality of fourth sub-pixels G arranged in the 8k-th column.

For example, according to an embodiment, as shown in FIG. 4, the display panel can include pixels that each include multiple sub-pixels, for example, red, green, blue, and white sub-pixels. These can be arranged so that sub-pixels of the same color are aligned into columns. The panel can further include data lines that each divide into multiple sub-data lines. In this configuration, the sub-data lines originating from a single data line are exclusively connected to sub-pixels that share the same color.

According to an embodiment, a first data voltage DATA1 as a red data voltage can be applied to the first data line DL1, and a second data voltage DATA2 as a white data voltage can be applied to the second data line DL2. In addition, a third data voltage DATA3 as a blue data voltage can be applied to the third data line DL3, and a fourth data voltage DATA4 as a green data voltage can be applied to the fourth data line DL4.

Accordingly, the first data voltage DATA1 as a red data voltage can also be applied to the plurality of first sub-data lines SDL1-a and SDL1-b, and the second data voltage DATA2 as a white data voltage can also be applied to the plurality of second sub-data lines SDL2-a and SDL2-b. In addition, the third data voltage DATA3 as a blue data voltage can also be applied to the plurality of third sub-data lines SDL3-a and SDL3-b, and the fourth data voltage DATA4 as a green data voltage can also be applied to the plurality of fourth sub-data lines SDL4-a and SDL4-b.

According to an embodiment, each of the plurality of gate lines GL1 to GL4 can be disposed on each of both opposing sides in the column direction of a row of the plurality of sub-pixels R, G, B, and W. Two gate lines GL2 and GL3 can be disposed between adjacent rows of the plurality of sub-pixels R, G, B, and W. For example, according to an embodiment, each row of sub-pixels can be positioned between a pair of gate lines. Thus, two gate lines can be disposed in the space between adjacent rows of sub-pixels, as shown in FIG. 4.

Specifically, referring to FIG. 4, the first gate line GL1 and the second gate line GL2 can be respectively disposed on both opposing sides in the column direction of the plurality of sub-pixels R, G, B, and W of the odd-numbered row, while the third gate line GL3 and the fourth gate line GL4 can be respectively disposed on both opposing sides in the column direction of the plurality of sub-pixels R, G, B, and W of the even-numbered row. Accordingly, the second gate line GL2 and the third gate line GL3 can be disposed between the plurality of sub-pixels R, G, B, and W arranged in the odd-numbered row and the plurality of sub-pixels R, G, B, and W arranged in the even-numbered row even.

Each of the plurality of pixels PX can be connected to the same gate line GL1 to GL4, and adjacent pixels PX among the plurality of pixels PX can be connected to different gate lines GL1 to GL4.

Specifically, referring to FIG. 4, the sub-pixels R, W, B, and G arranged in a (8k−7)th column to the (8k−4)th column of the odd-numbered row odd can be connected to the first gate line GL1, and the sub-pixels R, W, B, and G arranged in a (8k−3)th column to the 8k-th column of the odd-numbered row odd can be connected to the second gate line GL2. In addition, the sub-pixels R, W, B, and G arranged in a (8k−7)th column to the (8k−4)th column of the even-numbered row even can be connected to the third gate line GL3, and the sub-pixels R, W, B, and G arranged in a (8k−3)th column to the 8k-th column of the even-numbered row even can be connected to the fourth gate line GL4.

Each of the plurality of reference voltage lines RVL can be disposed inside one pixel PX, and each of the plurality of high potential voltage lines VDDL can be disposed between adjacent ones of the plurality of pixels PX.

Specifically, one of the plurality of reference voltage lines RVL can be disposed between the plurality of second sub-pixels W arranged in a (8k−6)th column and the plurality of third sub-pixels B arranged in a (8k−5)th column, and another thereof can be disposed between the plurality of second sub-pixels W arranged in a (8k−2)th column and the plurality of third sub-pixels B arranged in a (8k−1)th column.

One of the plurality of high potential voltage lines VDDL can be disposed between the plurality of fourth sub-pixels G arranged in a (8k−4)th column and the plurality of first sub-pixels R arranged in a (8k−3)th column, and another thereof can be disposed outside and on a left side of the plurality of first sub-pixels R arranged in a (8k−7)th column, and still another thereof can be disposed outside and on a right side of the plurality of fourth sub-pixels G arranged in a 8k-th column. For example, according to an embodiment, reference voltage lines can be disposed within each pixel, and high-potential voltage lines can be disposed between adjacent pixels. For instance, a reference voltage line can be positioned between the columns of white and blue sub-pixels, while a high-potential voltage line can be positioned between the columns of green and red sub-pixels, as shown in FIG. 4.

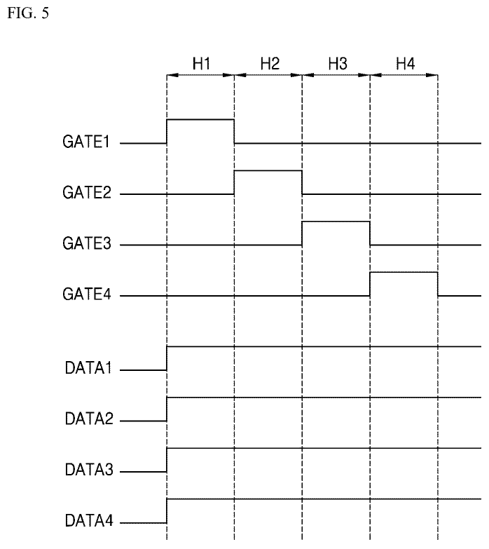

Hereinafter, a method of driving a monochromatic still screen and a method of driving a vertical pattern screen of the display device 100 according to an embodiment of the present disclosure will be described with reference to FIGS. 4 and 5.

FIG. 5 is a timing diagram of a gate voltage and a data voltage when a display device according to an embodiment of the present disclosure displays a monochromatic still screen.

As shown in FIGS. 4 and 5, the first gate voltage GATE1 is output via the first gate line GL1, the second gate voltage GATE2 is output via the second gate line GL2, the third gate voltage GATE3 is output via the third gate line GL3, and the fourth gate voltage GATE4 is output via the fourth gate line GL4.

In addition, the first data voltage DATA1 is output via the first data line DL1, the second data voltage DATA2 is output via the second data line DL2, the third data voltage DATA3 is output via the third data line DL3, and the fourth data voltage DATA4 is output via the fourth data line DL4.

As illustrated in FIG. 5, during a first horizontal period H1, the first gate voltage GATE1 is the gate high voltage, and the second gate voltage GATE2, the third gate voltage GATE3, and the fourth gate voltage GATE4 are the gate low voltages. In addition, during the first horizontal period H1, each of the first data voltage DATA1 to the fourth data voltage DATA4 can be a data voltage of a predetermined level for implementing a predetermined grayscale.

Accordingly, during the first horizontal period H1, all of the switching transistors respectively connected to the plurality of first sub-pixels R arranged in a (8k−7)th column, the plurality of second sub-pixels W arranged in a (8k−6)th column, the plurality of third sub-pixels B arranged in a (8k−5)th column, and the plurality of fourth sub-pixels G arranged in a (8k−4)th column are turned on.

Accordingly, during the first horizontal period H1, in the odd-numbered row odd, the first data voltage DATA1 can be charged into the plurality of first sub-pixels R arranged in a (8k−7)th column, the second data voltage DATA2 can be charged into the plurality of second sub-pixels W arranged in a (8k−6)th column, the third data voltage DATA3 can be charged into the plurality of third sub-pixels B arranged in a (8k−5)th column, and the fourth data voltage DATA4 can be charged into the plurality of fourth sub-pixels G arranged in a (8k−4)th column.

As illustrated in FIG. 5, during a second horizontal period H2, the second gate voltage GATE2 is the gate high voltage, and the first gate voltage GATE1, the third gate voltage GATE3, and the fourth gate voltage GATE4 are the gate low voltages. In addition, even during the second horizontal period H2, each of the first data voltage DATA1 to the fourth data voltage DATA4 can be a data voltage of a predetermined level for implementing a predetermined gray level.

Accordingly, during the second horizontal period H2, all of the switching transistors respectively connected to the plurality of first sub-pixels R arranged in a (8k−3)th column, the plurality of second sub-pixels W arranged in a (8k−2)th column, the plurality of third sub-pixels B arranged in a (8k−1)th column, and the plurality of fourth sub-pixels G arranged in a 8k-th column in the odd-numbered row are turned on.

Accordingly, during the second horizontal period H2, in the odd-numbered row odd, the first data voltage DATA1 can be charged into the plurality of first sub-pixels R arranged in a (8k−3)th column, the second data voltage DATA2 can be charged into the plurality of second sub-pixels W arranged in a (8k−2)th column, the third data voltage DATA3 can be charged into the plurality of third sub-pixels B arranged in a (8k−1)th column, and the fourth data voltage DATA4 can be charged into the plurality of fourth sub-pixels G arranged in a 8k-th column.

As illustrated in FIG. 5, during a third horizontal period H3, the third gate voltage GATE3 is the gate high voltage, and the first gate voltage GATE1, the second gate voltage GATE2, and the fourth gate voltage GATE4 are the gate low voltages. In addition, even during the third horizontal period H3, each of the first data voltage DATA1 to the fourth data voltage DATA4 can be a data voltage of a predetermined level for implementing a predetermined grayscale.

Accordingly, during the third horizontal period H3, all of the switching transistors respectively connected to the plurality of first sub-pixels R arranged in a (8k−7)th column, the plurality of second sub-pixels W arranged in a (8k−6)th column, the plurality of third sub-pixels B arranged in a (8k−5)th column, and the plurality of fourth sub-pixels G arranged in a (8k−4)th column in the even-numbered row even are turned on.

Accordingly, during the third horizontal period H3, in the even-numbered row even, the first data voltage DATA1 can be charged into the plurality of first sub-pixels R arranged in a (8k−7)th column, the second data voltage DATA2 can be charged into the plurality of second sub-pixels W arranged in a (8k−6)th column, the third data voltage DATA3 can be charged into the plurality of third sub-pixels B arranged in a (8k−5)th column, and the fourth data voltage DATA4 can be charged into the plurality of fourth sub-pixels G arranged in a (8k−4)th column.

As illustrated in FIG. 5, during a fourth horizontal period H4, the fourth gate voltage GATE4 is the gate high voltage, and the first gate voltage GATE1, the second gate voltage GATE2, and the third gate voltage GATE3 are the gate low voltages. In addition, even during the third horizontal period H3, each of the first data voltage DATA1 to the fourth data voltage DATA4 can be a data voltage of a predetermined level for implementing a predetermined grayscale.

Accordingly, during the fourth horizontal period H4, all of the switching transistors respectively connected to the plurality of first sub-pixels R arranged in a (8k−3)th column, the plurality of second sub-pixels W arranged in a (8k−2)th column, the plurality of third sub-pixels B arranged in a (8k−1)th column, and the plurality of fourth sub-pixels G arranged in a 8k-th column in the even-numbered row even are turned on.

Accordingly, during the fourth horizontal period H4, in the even-numbered row even, the first data voltage DATA1 can be charged into the plurality of first sub-pixels R arranged in a (8k−3)th column, the second data voltage DATA2 can be charged into the plurality of second sub-pixels W arranged in a (8k−2)th column, the third data voltage DATA3 can be charged into the plurality of third sub-pixels B arranged in a (8k−1)th column, and the fourth data voltage DATA4 can be charged into the plurality of fourth sub-pixels G arranged in a 8k-th column.

For example, as illustrated in FIG. 5, the display panel can be driven by a sequence of four horizontal periods (e.g., H1, H2, H3, and H4). During each horizontal period, a corresponding gate line (e.g., GATE1-GATE4) receives a gate high voltage while the other gate lines receive a gate low voltage. This activation turns on the switching transistors for a corresponding set of sub-pixels, allowing data voltages (e.g., DATA1-DATA4) to be charged into them to implement a predetermined grayscale. This process addresses the sub-pixels in a specific sequence, in which during H1, a first set of sub-pixel columns in the odd-numbered rows is charged (e.g., the upper left pixel unit in FIG. 4) during H2, a second set of sub-pixel columns in the odd-numbered rows is charged (e.g., the upper right pixel unit in FIG. 4). Similarly, periods H3 and H4 respectively charge the first and second sets of sub-pixel columns in the even-numbered rows (e.g., lower left pixel unit, and lower right pixel unit).

As described above, when the display device 100 according to an embodiment of the present disclosure displays the monochromatic still screen, each of the first data voltage to the fourth data voltage DATA1 to DATA4 can have the same level during the first horizontal period to the fourth horizontal period H1 to H4, that is, during one frame. Accordingly, each of the first data voltage to the fourth data voltage DATA1 to DATA4 is maintained at a constant data voltage level during one frame.

The display device operates in a DRD (double rate driving) manner using the data line division into the sub-data lines at a lower end of a link for the DRD application. The DRD scheme shares two sub-data lines, thereby increasing the RC delay. In other words, the display device uses a Double Rate Driving (DRD) method to achieve a higher refresh rate. It does this by splitting each main data line into sub-data lines at the end of the signal path. However, this technique of sharing one main line between two sub-lines increases the electrical load, causing a signal lag (RC delay) that can hurt performance.

In order to solve this problem, the present disclosure provides a display device in which five sub-pixels operate via two sub-data lines such that the number of sub-data lines is reduced and the data voltage is shared by the sub-data lines.

To this end, the display device according to an embodiment of the present disclosure can drive two or three sub-pixels via the first sub-data line, and drive three or two sub-pixels via the second sub-data line. In addition, the five sub-pixels can be arranged in a flip structure with respect to each other.

Accordingly, in the display device according to an embodiment of the present disclosure, a sub-data line is not required for one of the five pixels, and the five sub-pixels can operate based on the 2.5 RD as a median between the DRD and the triple rate driving (TRD).

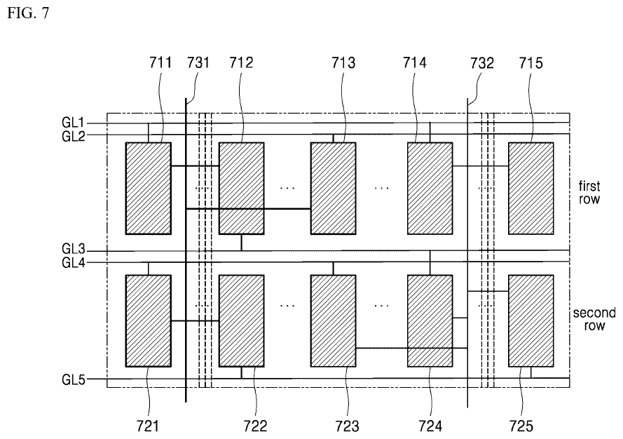

In other words, to address the aforementioned problems, according to an embodiment, the disclosed display device can utilize an improved “2.5 RD” driving architecture. In this scheme, a group of five sub-pixels can be efficiently operated by only two data lines which can reduce wiring complexity. This can be accomplished by connecting the first data line to two or three of the sub-pixels and the second data line to the remaining three or two. The functionality of this shared voltage system can be enabled by arranging the five sub-pixels in a symmetrical flip type structure as shown in FIG. 7. As a result, this method can achieve an effective driving rate of 2.5 sub-pixels per data line to creating an optimal median between Double Rate Driving (DRD) and Triple Rate Driving (TRD) techniques. Features of the 2.5 RD configuration are discussed in more detail below, e.g., with reference to FIG. 7.

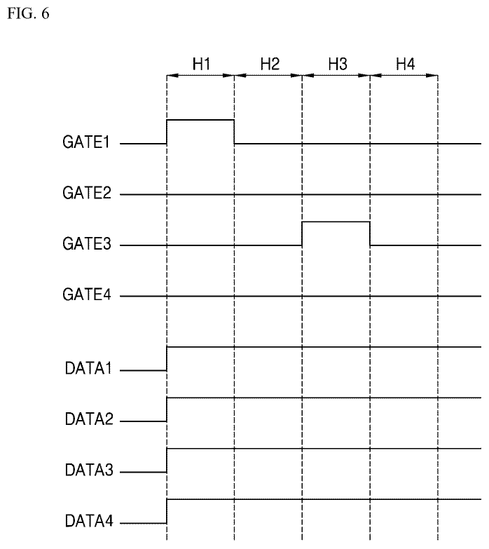

FIG. 6 is a timing diagram for a gate voltage and a data voltage when a display device according to an embodiment of the present disclosure displays a vertical pattern screen.

As illustrated in FIG. 6, during the first horizontal period H1, the first gate voltage GATE1 is a gate high voltage, and the second gate voltage GATE2, the third gate voltage GATE3, and the fourth gate voltage GATE4 are gate low voltages. In addition, during the first horizontal period H1, each of the first data voltage DATA1 to the fourth data voltage DATA4 can be a data voltage of a predetermined level for implementing a predetermined grayscale.

Accordingly, during the first horizontal period H1, all of the switching transistors respectively connected to the plurality of first sub-pixels R arranged in a (8k−7)th column, the plurality of second sub-pixels W arranged in a (8k−6)th column, the plurality of third sub-pixels B arranged in a (8k−5)th column, and the plurality of fourth sub-pixels G arranged in a (8k−4)th column in the odd-numbered row odd are turned on.

Accordingly, during the first horizontal period H1, in the odd-numbered row odd, the first data voltage DATA1 can be charged into the plurality of first sub-pixels R arranged in a (8k−7)th column, the second data voltage DATA2 can be charged into the plurality of second sub-pixels W arranged in a (8k−6)th column, the third data voltage DATA3 can be charged into the plurality of third sub-pixels B arranged in a (8k−5)th column, and the fourth data voltage DATA4 can be charged into the plurality of fourth sub-pixels G arranged in a (8k−4)th column.

As illustrated in FIG. 6, during the second horizontal period H2, all of the first gate voltage GATE1, the second gate voltage GATE2, the third gate voltage GATE3, and the fourth gate voltage GATE4 are gate low voltages. In addition, even during the second horizontal period H2, each of the first data voltage DATA1 to the fourth data voltage DATA4 can be a data voltage of a predetermined level for implementing a predetermined gray level.

Accordingly, during the second horizontal period H2, all of the switching transistors respectively connected to all sub-pixels are turned off. Accordingly, during the second horizontal period H2, in the odd-numbered row odd, the first data voltage DATA1 is not charged into the plurality of first sub-pixels R arranged in a (8k−3)th column, the second data voltage DATA2 is not charged into the plurality of second sub-pixels W arranged in a (8k−2)th column, the third data voltage DATA3 is not charged into the plurality of third sub-pixels B arranged in a (8k−1)th column, and the fourth data voltage DATA4 is not charged into the plurality of fourth sub-pixels G arranged in a 8k-th column.

As illustrated in FIG. 6, during the third horizontal period H3, the third gate voltage GATE3 is the gate high voltage, and the first gate voltage GATE1, the second gate voltage GATE2, and the fourth gate voltage GATE4 are the gate low voltages. In addition, even during the third horizontal period H3, each of the first data voltage DATA1 to the fourth data voltage DATA4 can be a data voltage of a predetermined level for implementing a predetermined grayscale.

Accordingly, during the third horizontal period H3, all of the switching transistors respectively connected to the plurality of first sub-pixels R arranged in a (8k−7)th column, the plurality of second sub-pixels W arranged in a (8k−6)th column, the plurality of third sub-pixels B arranged in a (8k−5)th column, and the plurality of fourth sub-pixels G arranged in a (8k−4)th column in the even-numbered row even are turned on.

Accordingly, during the third horizontal period H3, in the even-numbered row even, the first data voltage DATA1 can be charged into the plurality of first sub-pixels R arranged in a (8k−7)th column, the second data voltage DATA2 can be charged into the plurality of second sub-pixels W arranged in a (8k−6)th column, the third data voltage DATA3 can be charged into the plurality of third sub-pixels B arranged in a (8k−5)th column, and the fourth data voltage DATA4 can be charged into the plurality of fourth sub-pixels G arranged in a (8k−4)th column.

As illustrated in FIG. 6, during the fourth horizontal period H4, all of the first gate voltage GATE1, the second gate voltage GATE2, the third gate voltage GATE3, and the fourth gate voltage GATE4 are gate low voltages. In addition, even during the fourth horizontal period H4, each of the first data voltage DATA1 to the fourth data voltage DATA4 can be a data voltage of a predetermined level for implementing a predetermined grayscale.

Accordingly, during the fourth horizontal period H4, all switching transistors connected to all sub-pixels SP are turned off. Accordingly, during the fourth horizontal period H4, in the even-numbered row even, the first data voltage DATA1 may not be charged into the plurality of first sub-pixels R arranged in a (8k−3)th column, the second data voltage DATA2 may not be charged into the plurality of second sub-pixels W arranged in a (8k−2)th column, the third data voltage DATA3 may not be charged into the plurality of third sub-pixels B arranged in a (8k−1)th column, and the fourth data voltage DATA4 may not be charged into the plurality of fourth sub-pixels G arranged in a 8k-th column.

As described above, when the display device 100 according to an embodiment of the present disclosure displays the vertical pattern screen, each of the first data voltage DATA1 to the fourth data voltage DATA4 can be at the same level during the first horizontal period to the fourth horizontal period H 4, that is, during one frame. Accordingly, each of the first data voltage DATA1 to the fourth data voltage DATA4 is maintained at a constant data voltage during one frame.

For example, FIG. 6 illustrates a timing diagram for displaying a vertical pattern screen. In this operational mode, the driving sequence alternates between active and inactive periods. During the first horizontal period (H1), the first gate line (GATE1) is activated to apply data voltages to the odd-numbered rows. Subsequently, during the second horizontal period (H2), all gate lines are held low and no sub-pixels are charged. This pattern repeats, with the third gate line (GATE3) activating the even-numbered rows during H3, followed by another inactive period (H4) where all gates are low. An aspect of displaying a static vertical pattern is that the data voltages (DATA1-DATA4) remain constant for the entire frame, as the vertical lines are drawn for each row.

In a conventional display device, two sub-pixels emitting different colors are connected to one data line (e.g., one same wire for different colors). Accordingly, in the conventional display device, the data voltage applied to the data line should be a data voltage corresponding to a plurality of different colors, change in the data voltage (data transition) is required. That is, a data voltage change (data transition) can occur even within one horizontal period, and data voltage change (data transition) should occur within at least one frame.

Accordingly, when the data voltage change (data transition) frequently occurs, the data voltage is not completely charged during one horizontal period. Further. when the data voltage change (data transition) frequently occurs, the heat generation from the data driver supplying the data voltage is increased and power consumption increases which can waste energy. In other words, conventional displays are inefficient because they often use a single data line to control sub-pixels of different colors. This forces the display device to constantly change the voltage signal or switch it back and forth, which can lead to inaccurate or not fully charged colors (e.g., because the signal cannot keep up) and wasted energy (e.g., in the form of heat and high power consumption).

On the other hand, in the display device according to an embodiment of the present disclosure, each of the plurality of data lines DL1, DL2, DL3, and DL4 can divide into the plurality of sub-data lines SDL1-a and SDL1-b, SDL2-a and SDL2-b, SDL3-a and SDL3-b, or SDL4-a and SDL4-b. The plurality of sub-data lines SDL1-a and SDL1-b, SDL2-a and SDL2-b, SDL3-a and SDL3-b, or SDL4-a and SDL4-b can be connected to the sub-pixels R, G, B, or W emitting light of the same color (e.g., dedicated lines for each different color). Accordingly, in the display device according to an embodiment of the present disclosure, the plurality of data lines only need to output the data voltage corresponding to one color. Thus, when a single-color still screen or a vertical pattern screen is implemented, the data voltage change (data transition) does not occur during one frame.

Accordingly, the data voltage can be completely charged during one frame, thereby solving the problem of incomplete charging of the data voltage in the conventional display device. In addition, since the data voltage is kept constant during one frame, the heat generation phenomenon from the data driver supplying the data voltage can also be reduced.

Moreover, even when the display device displays the vertical pattern screen, the data voltage change (data transition) does not occur during one frame, so that the burden of the data driver can be minimized when the pattern vertical pattern screen is implemented. In other words, according to an embodiment, the disclosed display device can dedicate each data line and its corresponding sub-data lines to sub-pixels of the same, single color. This architecture can eliminate the need for frequent data voltage changes (e.g., data transitions) when displaying a monochromatic still screen or a vertical pattern, as the data voltage can remain constant for an entire frame. Consequently, this stable voltage ensures that sub-pixels are completely charged, improving visual accuracy. Furthermore, it can significantly reduce the heat generated by the data driver and minimizes its operational load, leading to improved power efficiency.

Hereinafter, a display device according to another embodiment of the present disclosure will be described.

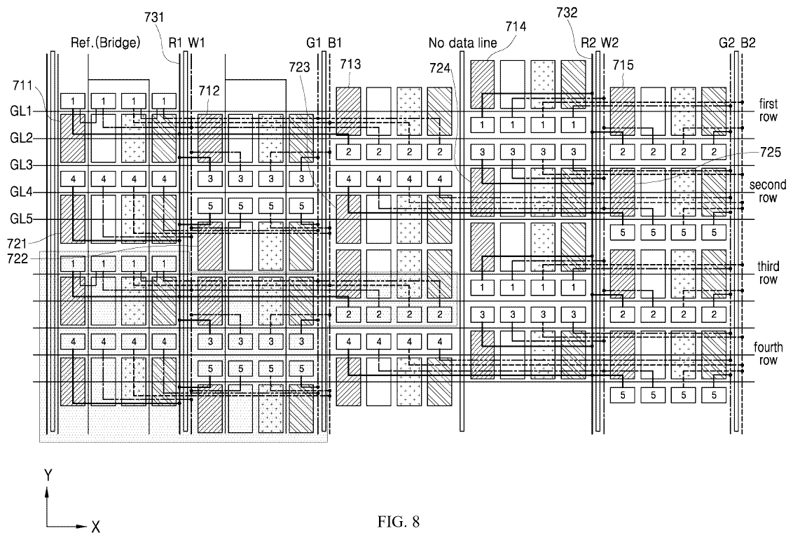

FIG. 7 is an example diagram illustrating a connection relationship between the sub-pixels emitting light of the same color and a gate line and sub-data lines in order to drive five sub-pixels using two sub-data lines in a display device according to an embodiment of the present disclosure. FIG. 8 is an example diagram illustrating an arrangement relationship of sub-pixels operating using two sub-data lines in a display device according to an embodiment of the present disclosure.

FIG. 7 illustrates only specific sub-pixels R 711, 712, 713, 714, 715, 721, 722, 723, 724, and 725 among a plurality of sub-pixels. However, of course, as can be understood, other sub-pixels G, B, and W are included in the display device (e.g., in locations including “. . . ”), and FIG. 8 illustrates an arrangement relationship of the plurality of sub-pixels R, G, B, and W.

Referring to FIGS. 7 and 8, the display panel according to an embodiment of the present disclosure can drive five pixels arranged in the same row using two data lines.

According to an embodiment, each sub-data line of the data line DL can be disposed between adjacent ones of a plurality of sub-pixels SP. For example, a first sub-data line 731 can be disposed on the right side of the sub-pixels R 711 and 721 of a first column, and a second sub-data line 732 can be disposed on the right side of the sub-pixels R 714 and 724 of a fourth column. Also, the sub-data lines can be referred to as bridge data lines and can extend in a horizontal direction, but embodiments are not limited thereto.

In addition, the first sub-data lines R1 and W1 can be disposed between the sub-pixels SP of the first column and the sub-pixels SP of the second column, the first sub-data lines G1 and B1 can be disposed between the sub-pixels SP of the second column and the sub-pixels SP of the third column, the second sub-data lines R2 and W2 can be disposed between the sub-pixels SP of the fourth column and the sub-pixels SP of the fourth column, and the second sub-data lines G2 and B2 can be disposed between the sub-pixels SP of the fifth column and the sub-pixels SP of the sixth column. In addition, in the present disclosure, the sub-pixels R, G, B, and W of the display panel 110 can operate even in a state (No data line state) in which the sub-data line is not disposed between the sub-pixels SP of the third column and the sub-pixels SP of the fourth column. For example, the display panel architecture enables five pixels in a single row to be driven by only two data lines. This efficiency is achieved through a specific layout where sub-data lines are positioned between most adjacent sub-pixel columns. Further, a feature of this design is the intentional absence of a data line between the third and fourth columns. This gap in the wiring scheme can allow a space for other types of wiring, such as a high potential voltage line.

As shown in FIGS. 7 and 8, the first sub-data line 731 according to an embodiment can be disposed to supply a data voltage to the sub-pixels R 711, 712, and 713 of the first row and the sub-pixels R 721 and 722 of the second row, and the second sub-data line 732 can be disposed to supply a data voltage to the sub-pixels R 714 and 715 of the first row and the sub-pixels R 723, 724, and 725 of the second row, providing a flip style or mirrored arrangement where the number of sub-pixels driven by each sub-data line is inverted between adjacent rows. For example, a first data voltage as a red data voltage can be applied to the first sub-data line 731 and the second sub-data line 732. Also, the sub-data lines can be referred to as bridge data lines and can extend in a horizontal direction, but embodiments are not limited thereto.

According to an embodiment, the first gate line GL1 is disposed on one side (upper side in the drawing) in the column direction of the sub-pixels 711 and 714 of the first row and is connected to the driving circuit of each of the first sub-pixel 711 and the fourth sub-pixel 714 of the first row.

According to an embodiment, the second gate line GL2 is disposed on one side (upper side in the drawing) in the column direction of the sub-pixels 713 and 715 of the first row and is connected to the driving circuit of the third sub-pixel 713 of the first row.

According to an embodiment, the third gate line GL3 is disposed on the other side (lower side in the drawing) in the column direction of the sub-pixels 712 and 715 of the first row and is connected to the driving circuit of each of the first sub-pixel 713 and the fifth sub-pixel 715 of the first row.

According to an embodiment, the fourth gate line GL4 is disposed on one side (upper side in the drawing) in the column direction of the sub-pixels 721 and 724 of the second row and is connected to the driving circuit of each of the first sub-pixel 721 and the fourth sub-pixel 724 of the second row.

According to an embodiment, the fifth gate line GL5 is disposed on the other side (lower side in the drawing) in the column direction of the sub-pixels 722 and 723 of the second row, and is connected to the driving circuit of each of the second sub-pixels 722 and the second sub-pixels 723 of the second row.

FIGS. 7 and 8 illustrate that the first sub-data line 731 is disposed to supply the data voltage to the sub-pixels R 711, 712, and 713 of the first row and the sub-pixels R 721 and 722 of the second row, and the second sub-data line 732 is disposed to supply the data voltage to the sub-pixels R 714 and 715 of the first row and the sub-pixels R 723, 724, and 725 of the second row.

The plurality of data lines of the present disclosure can be disposed in the display panel 110 so that each of the plurality of data lines can divide into or branch out into a plurality of sub-data lines, and the data voltage is applied to a predetermined multiple of sub-pixels emitting light of the same color via each of the plurality of sub-data lines. In the display panel 110, a plurality of sub-data lines can be disposed such that a data voltage is applied to five sub-pixels emitting light of the same color being arranged in the same row via two sub-data lines. As described above, the display panel 110 according to the present disclosure can include a plurality of pixels, each of the plurality pixels including a plurality of sub-pixels emitting light of different colors, and can include a plurality of data lines via which the data voltage supplied from the data driver 120 is supplied to the plurality of pixels, and a plurality of gate lines via which the gate signal provided from the gate driver 130 is supplied to the plurality of pixels. Each of the plurality of data lines can include a plurality of divided sub-data lines. Each of the plurality of sub-data lines can be disposed in the display panel 110 such that the data voltage supplied from the data driver 120 is applied to five sub-pixels emitting light of the same color being arranged in the same row via two sub-data lines. For example, according to an embodiment, the display panel can utilize a unique data line architecture where each data line branches into multiple sub-data lines. This structure is configured so that two data lines collectively supply a data voltage to a group of five sub-pixels, in which all five sub-pixels emit the same color of light and are arranged within the same row.

According to an embodiment, the plurality of sub-data lines can be disposed in the display panel 110 such that a data voltage is applied to three or two sub-pixels emitting light of the same color being arranged in the first row via the first sub-data line among the plurality of sub-data lines, or a data voltage is applied to two or three sub-pixels emitting light of the same color being arranged in the second row via the first sub-data line.

Accordingly, the display panel 110 can control the light emission order of the sub-pixels emitting light of the same color.

According to an embodiment, when the first gate voltage GATE1 at a turn-on level is applied via the first gate line GL1 in a state in which the data voltage is being supplied via the first sub-data line 731, the first gate signal is transmitted to the first sub-pixel 711 of the first row, and the data voltage can be charged into the first sub-pixel 711 of the first row, such that the first sub-pixel 711 of the first row emits light.

Thereafter, when the second gate voltage GATE2 at a turn-on level is applied via the second gate line GL2, the second gate signal is transmitted to the third sub-pixel 713 in the first row, and the data voltage can be charged into the third sub-pixel 713 in the first row, so that the third sub-pixel 713 in the first row emits light.

Thereafter, when the third gate voltage GATE3 at a turn-on level is applied via the third gate line GL3, the third gate signal is transmitted to the second sub-pixel 712 of the first row, and the data voltage can be charged into the second sub-pixel 712 of the first row, so that the second sub-pixel 712 of the first row emits light.

Thereafter, when the fourth gate voltage GATE4 at a turn-on level is applied via the fourth gate line GL4, the fourth gate signal is transmitted to the first sub-pixel 721 of the second row, and the data voltage can be charged into the first sub-pixel 721 of the second row, so that the first sub-pixel 721 of the second row emits light.

Thereafter, when the fifth gate voltage GATE5 at a turn-on level is applied via the fifth gate line GL5, the fifth gate signal is transmitted to the second sub-pixel 723 in the second row, and the data voltage can be charged into the second sub-pixel 722 in the second row, such that the second sub-pixel 722 in the second row emits light. As described above, in the display panel 110, in a state in which the data voltage is being supplied via the first sub-data line 731, the sub-pixels 711, 712, and 713 of the first row and the sub-pixels 721 and 722 of the second row emit light in the order of the first sub-pixel 711 of the first row, the third sub-pixel 713 of the first row, the second sub-pixel 712 of the first row, the first sub-pixel 721 of the second row, and the second sub-pixel 722 of the second row.

In other words, this architecture can enable precise control over the light emission order of the sub-pixels across different rows. By sequentially applying a turn-on voltage to the various gate lines (e.g., GL1-GL5), the corresponding sub-pixels are charged and emit light in a specific, pre-determined sequence. For instance, sequentially activating the first, second, and then third gate lines (e.g., GL1-GL3) causes sub-pixels 711, 713, and 712 in the first row to light up in that particular order, and then activating the fourth and fifth gate lines (e.g., GL4 and GL5) causes sub-pixels 721 and 722 in the second row to light up in order.

FIGS. 7 and 8 illustrate a light emission order of sub-pixels in a situation in which the first sub-data line 731 is disposed to supply a data voltage to the sub-pixels R 711, 712, and 713 of the first row and the sub-pixels R 721 and 722 of the second row, and the second sub-data line 732 is disposed to supply a data voltage to the sub-pixels R 714 and 715 of the first row and the sub-pixels R 723, 724, and 725 of the second row.

However, according to an alternative embodiment, in the display panel 110 of the present disclosure, the first sub-data line 731 can be disposed to supply the data voltage to the sub-pixels R 711 and 712 of the first row and the sub-pixels R 721, 722, and 723 of the second row, and the second sub-data line 732 can be disposed to supply the data voltage to the sub-pixels R 713, 714, and 715 of the first row and the sub-pixels R 724 and 725 of the second row.

According to an embodiment, when the first gate voltage GATE1 at a turn-on level is applied via the first gate line GL1 in a state in which the data voltage is being supplied via the second sub-data line 732, the first gate signal is transmitted to the fourth sub-pixel 714 of the first row, and the data voltage can be charged into the fourth sub-pixel 714 of the first row, such that the fourth sub-pixel 714 of the first row emits light.

Thereafter, when the third gate voltage GATE3 at a turn-on level is applied via the third gate line GL3, the third gate signal is transmitted to the fifth sub-pixel 715 in the first row, and the data voltage can be charged into the fifth sub-pixel 715 in the first row, so that the fifth sub-pixel 715 in the first row emits light.

Thereafter, when the fourth gate voltage GATE4 at a turn-on level is applied via the fourth gate line GL4, the fourth gate signal is transmitted to the fourth sub-pixel 724 in the second row, and the data voltage can be charged into the fourth sub-pixel 724 in the second row, such that the fourth sub-pixel 724 in the second row emits light.

Thereafter, when the fifth gate voltage GATE5 at a turn-on level is applied via the fifth gate line GL5, the fifth gate signal is transmitted to the third sub-pixel 723 of the second row, and the data voltage can be charged to the third sub-pixel 723 of the second row, so that the third sub-pixel 723 of the second row emits light.

Thereafter, when the fifth gate voltage GATE5 at a turn-on level is applied via the fifth gate line GL5, the fifth gate signal is transmitted to the fifth sub-pixel 725 in the second row, and the data voltage can be charged into the fifth sub-pixel 725 in the second row, so that the fifth sub-pixel 722 in the second row emits light.

As described above, in the display panel 110, in a state in which the data voltage is being supplied via the second sub-data line 732, the sub-pixels 714 and 715 in the first row and the sub-pixels 723, 724, and 725 in the second row emit light in the order of the fourth sub-pixel 714 in the first row, the fifth sub-pixel 715 in the first row, the fourth sub-pixel 724 in the second row, the third sub-pixel 723 in the second row, and the fifth sub-pixel 725 in the second row.

As described above, in the present disclosure, five sub-pixels can operate using two sub-data lines, and such sub-pixels can be arranged in up, down, left, and right directions.

Although FIGS. 7 and 8 illustrate a light emission order of specific sub-pixel R 711, 712, 713, 714, 715, 721, 722, 723, 724, and 725, the technical idea of the present disclosure as described above is equally applicable to other sub-pixels G, B, and W. In addition, although FIGS. 7 and 8 illustrate the light emission of the sub-pixels SP in the first row and the second row, the technical idea of the present disclosure as described above is equally applicable to the third row and the fourth row.

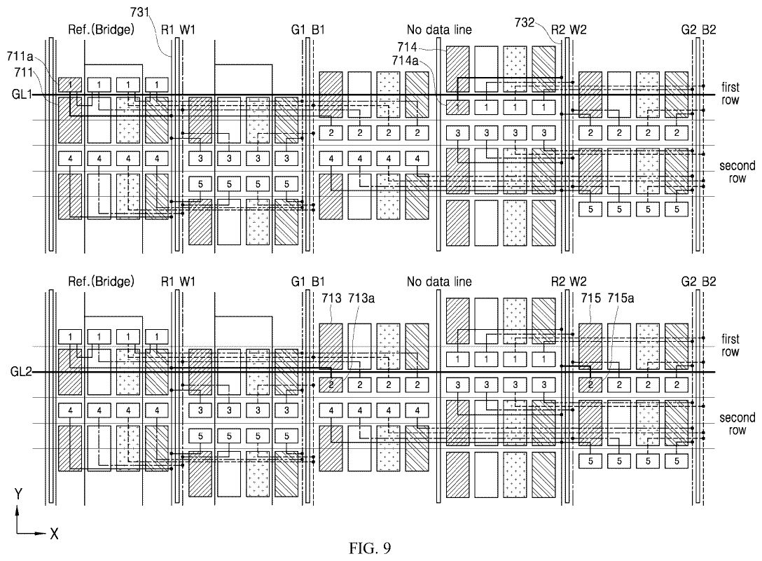

FIG. 9 is an example diagram illustrating a light emission state of a sub-pixel in a state in which a first gate voltage and a second gate voltage at a turn-on level are applied via a first gate line and a second gate line, respectively, according to an embodiment of the present disclosure.

According to an embodiment, the first sub-data line 731 can be disposed to supply a data voltage to the sub-pixels R 711, 712, and 713 of the first row and the sub-pixels R 721 and 722 of the second row, and the second sub-data line 732 can be disposed to supply a data voltage to the sub-pixels R 714 and 715 of the first row and the sub-pixels R 723, 724, and 725 of the second row.

According to an embodiment, when the first gate voltage GATE1 at a turn-on level is applied via the first gate line GL1, the first gate signal is transmitted to the driving circuit 711a of the first sub-pixel 711 of the first row, and the first gate voltage GATE1 can be charged into the driving circuit 711a of the first sub-pixel 711 of the first row. The first sub-pixel 711 of the first row emits light based on the first data voltage R1 applied via the first sub-data line 731.

In addition, when the first gate voltage GATE1 at a turn-on level is applied via the first gate line GL1, the first gate signal is transmitted to the driving circuit 714a of the fourth sub-pixel 714 in the first row, and the first gate voltage GATE1 can be charged into the driving circuit 714a of the fourth sub-pixel 714 in the first row. The fourth sub-pixel 714 of the first row emits light based on the second data voltage R2 applied via the second sub-data line 732.

According to an embodiment, when the second gate voltage GATE2 at a turn-on level is applied via the second gate line GL2, the second gate signal is transmitted to the driving circuit 713a of the third sub-pixel 713 in the first row, and the first gate voltage GATE1 can be charged into the driving circuit 713a of the third sub-pixel 713 in the first row. The third sub-pixel 713 of the first row emits light based on the first data voltage R1 applied via the first sub-data line 731.

In addition, when the second gate voltage GATE2 at a turn-on level is applied via the second gate line GL2, the second gate signal is transmitted to the driving circuit 715a of the fifth sub-pixel 715 in the first row, and the second gate voltage GATE2 can be charged into the driving circuit 715a of the fifth sub-pixel 715 in the first row. The fifth sub-pixel 715 of the first row emits light based on the second data voltage R2 applied via the second sub-data line 732.

Although FIG. 9 only discloses an operation order of specific sub-pixels R in each pixel PX, the technical idea of the present disclosure as described above is equally applicable to other sub-pixels G, B, and W in each pixel PX.

As described above, in the present disclosure, the sub-pixels R, G, B, and W of the display panel 110 can operate even in a state (No data line) in which the sub-data line is not disposed between the sub-pixels SP of the third column and the sub-pixels SP of the fourth column. For example, this can leave a space for other wiring lines, such as a high voltage driving line.

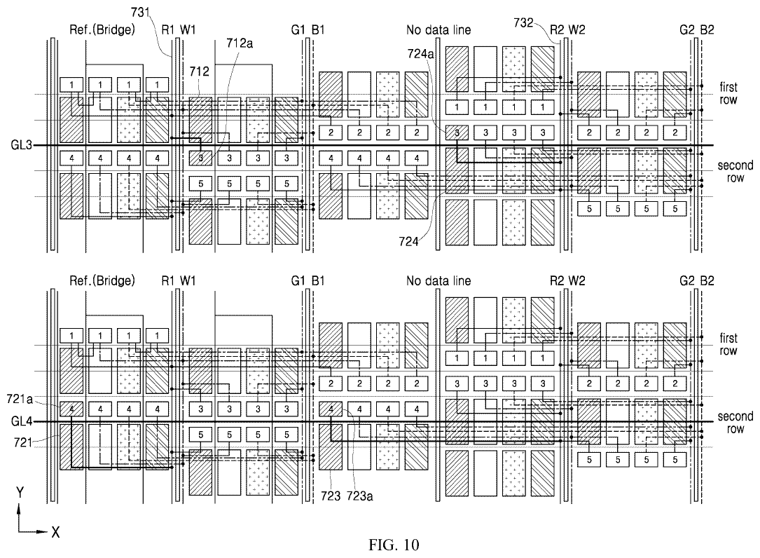

FIG. 10 is an example diagram illustrating a light emission state of a sub-pixel in a state in which a third gate voltage and a fourth gate voltage at a turn-on level are applied via a third gate line and a fourth gate line, respectively, according to an embodiment of the present disclosure.

According to an embodiment, the first sub-data line 731 can be disposed to supply a data voltage to the sub-pixels R 711, 712, and 713 of the first row and the sub-pixels R 721 and 722 of the second row, and the second sub-data line 732 can be disposed to supply a data voltage to the sub-pixels R 714 and 715 of the first row and the sub-pixels R 723, 724, and 725 of the second row. Also, the sub-data lines can be referred to as bridge data lines and can extend in a horizontal direction, but embodiments are not limited thereto.

According to an embodiment, when the third gate voltage GATE3 at a turn-on level is applied via the third gate line GL3, the third gate signal is transmitted to the driving circuit 712a of the second sub-pixel 712 of the first row, and the third gate voltage GATE3 can be charged into the driving circuit 712a of the second sub-pixel 712 of the first row. The second sub-pixel 712 of the first row emits light based on the first data voltage R1 applied via the first sub-data line 731.

In addition, when the third gate voltage GATE3 at a turn-on level is applied via the third gate line GL3, the third gate signal is transmitted to the driving circuit 724a of the fourth sub-pixel 724 in the second row, and the third gate voltage GATE3 can be charged into the driving circuit 724a of the fourth sub-pixel 724 in the second row. The fourth sub-pixel 724 of the second row emits light based on the second data voltage R2 applied via the second sub-data line 732.

According to an embodiment, when the fourth gate voltage GATE4 at a turn-on level is applied via the fourth gate line GL4, the fourth gate signal is transmitted to the driving circuit 721a of the first sub-pixel 721 of the second row, and the fourth gate voltage GATE4 can be charged into the driving circuit 721a of the first sub-pixel 721 of the second row. The first sub-pixel 721 of the second row emits light based on the first data voltage R1 applied via the first sub-data line 731.

In addition, when the fourth gate voltage GATE4 at a turn-on level is applied via the fourth gate line GL4, the fourth gate signal is transmitted to the driving circuit 723a of the third sub-pixel 723 in the second row, and the fourth gate voltage GATE4 can be charged into the driving circuit 723a of the third sub-pixel 723 in the second row. The third sub-pixel 723 of the second row emits light based on the second data voltage R2 applied via the second sub-data line 732.

FIG. 10 only discloses an operation order of the specific sub-pixels R in each pixel PX. However, the technical idea of the present disclosure as described above is equally applicable to other sub-pixels G, B, and W in each pixel PX.

As described above, in the present disclosure, the sub-pixels R, G, B, and W of the display panel 110 can operate even in a state (No data line) in which the sub-data line is not disposed between the sub-pixels SP of the third column and the sub-pixels SP of the fourth column. For example, leaving a space where other wiring lines can go.

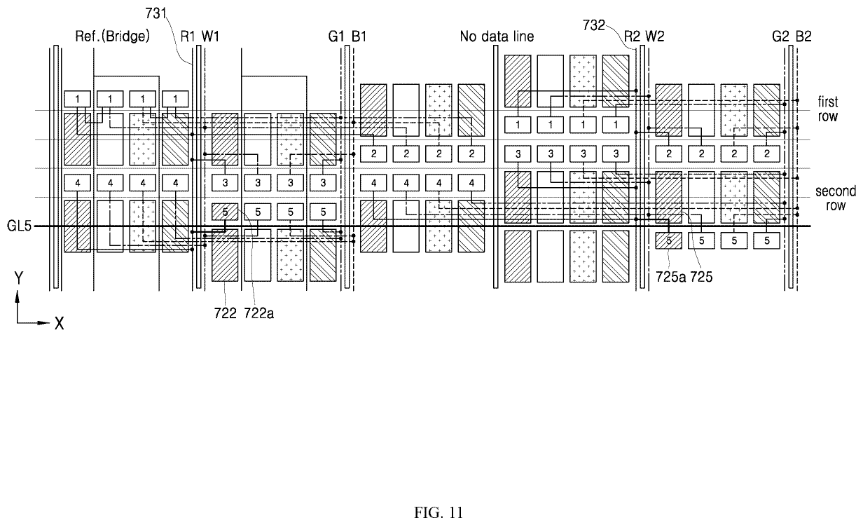

FIG. 11 is an example diagram illustrating a light emission state of a sub-pixel in a state in which a fifth gate voltage at a turn-on level is applied via a fifth gate line according to an embodiment of the present disclosure.

According to an embodiment, the first sub-data line 731 can be disposed to supply a data voltage to the sub-pixels R 711, 712, and 713 of the first row and the sub-pixels R 721 and 722 of the second row, and the second sub-data line 732 can be disposed to supply a data voltage to the sub-pixels R 714 and 715 of the first row and the sub-pixels R 723, 724, and 725 of the second row. Also, the sub-data lines can be referred to as bridge data lines and can extend in a horizontal direction, but embodiments are not limited thereto.

According to an embodiment, when the fifth gate voltage GATE5 at a turn-on level is applied via the fifth gate line GL5, the fifth gate signal is transmitted to the driving circuit 722a of the second sub-pixel 722 of the second row, and the fifth gate voltage GATE5 can be charged into the driving circuit 722 a of the second sub-pixel 722 of the second row. The second sub-pixel 722 of the second row emits light based on the first data voltage R1 applied via the first sub-data line 731.

In addition, when the fifth gate voltage GATE5 at a turn-on level is applied via the fifth gate line GL5, the fifth gate signal is transmitted to the driving circuit 725a of the fifth sub-pixel 725 in the second row, and the fifth gate voltage GATE5 can be charged into the driving circuit 725a of the fifth sub-pixel 725 in the second row. The fifth sub-pixel 725 of the second row emits light based on the second data voltage R2 applied via the second sub-data line 732.

Although FIG. 11 only discloses an operation order of specific sub-pixels R in each pixel PX, the technical idea of the present disclosure as described above is equally applicable to other sub-pixels G, B, and W in each pixel PX.

As described above, in the present disclosure, the sub-pixels R, G, B, and W of the display panel 110 can operate even in a state (No data line) in which the sub-data line is not disposed between the sub-pixels SP of the third column and the sub-pixels SP of the fourth column.

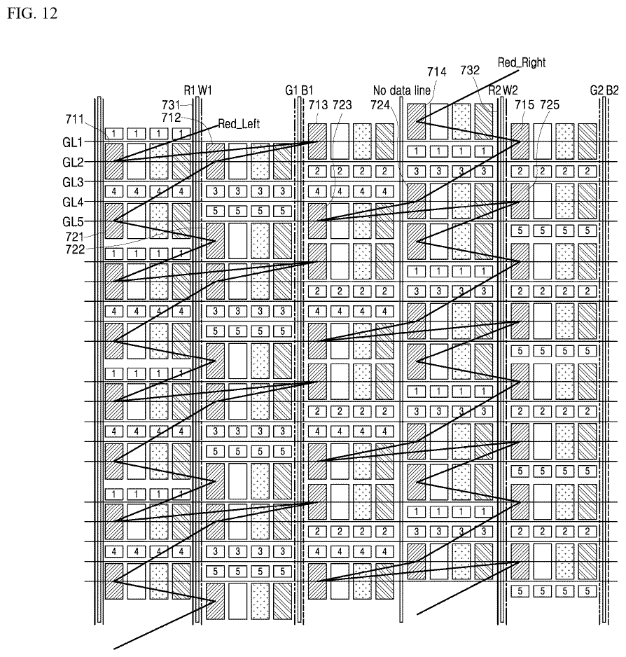

FIG. 12 is an example diagram illustrating an operation order of a pixel according to an embodiment of the present disclosure.

Referring to FIG. 12, in a state in which the data voltage is being supplied to the sub-pixels R via the first sub-data line 731 and the second sub-data line 732, respectively, the first gate voltage GATE1 at a turn-on level is applied via the first gate line GL1. Thus, the first gate signal is transmitted to the first sub-pixel 711 and the fourth sub-pixel 714 of the first row. The data voltage can be charged into the first sub-pixel 711 and the fourth sub-pixel 714 of the first row, so that the first sub-pixel 711 and the fourth sub-pixel 714 of the first row emit light.

Thereafter, when the second gate voltage GATE2 at a turn-on level is applied via the second gate line GL2, the second gate signal is transmitted to the third sub-pixel 713 in the first row and the fifth sub-pixel 715 in the first row. Thus, the data voltage can be charged into the third sub-pixel 713 and the fifth sub-pixel 715 of the first row, so that the third sub-pixel 713 and the fifth sub-pixel 715 of the first row emit light.

Thereafter, when the third gate voltage GATE3 at a turn-on level is applied via the third gate line GL3, the third gate signal is transmitted to the second sub-pixel 712 in the first row and the fourth sub-pixel 724 in the second row. Thus, the data voltage can be charged into the second sub-pixel 712 of the first row and the fourth sub-pixel 724 of the second row, and thus the second sub-pixel 712 of the first row and the fourth sub-pixel 724 of the second row emit light.

Thereafter, when the fourth gate voltage GATE4 at a turn-on level is applied via the fourth gate line GL4, the fourth gate signal is transmitted to the first sub-pixel 721 in the second row and the third sub-pixel 723 in the second row. Thus, a data voltage can be charged into the first sub-pixel 721 and the third sub-pixel 723 of the second row, and thus the first sub-pixel 721 and the third sub-pixel 723 of the second row emit light.

Thereafter, when the fifth gate voltage GATE5 at a turn-on level is applied via the fifth gate line GL5, the fifth gate signal is transmitted to the second sub-pixel 722 of the second row and the fifth sub-pixel 725 of the second row. Thus, the second sub-pixel 722 and the fifth sub-pixel 725 of the second row are charged with the data voltage, and thus the second sub-pixel 722 and the fifth sub-pixel 725 of the second row emit light.

In other words, as shown in FIG. 12, this driving method activates pairs of sub-pixels simultaneously. With a data voltage supplied via both sub-data lines (e.g., 731 and 732), sequentially applying turn-on voltages to the gate lines (GL1-G5) activates a specific pair of sub-pixels at each step. For example, applying the first gate voltage (GL1) causes another two sub-pixels in the first row (711 and 714) to emit light, applying the second gate voltage (GL2) causes two sub-pixels in the first row (713 and 715) to emit light, while applying the third gate voltage (GL3) simultaneously activates one sub-pixel in the first row (712) and one sub-pixel in the second row (724), applying the fourth gate voltage (GL4) causes another two sub-pixels in the second row (721 and 723) to emit light, and applying the fifth gate voltage (GL5) causes another two sub-pixels in the second row (722 and 725) to emit light.

In addition, simultaneously activating pairs of sub-pixels of the same color to emit light at the same time is an example according to one embodiment, and the process can be expanded to cause groups of 3 or more sub-pixels of the same color to simultaneously emit light. e.g., by using three or more sub-data lines with more branching lines, according to embodiments.

The display panel 110 of the present disclosure can perform light emission by repeatedly performing the above-described emission pattern related to the sub-pixel.

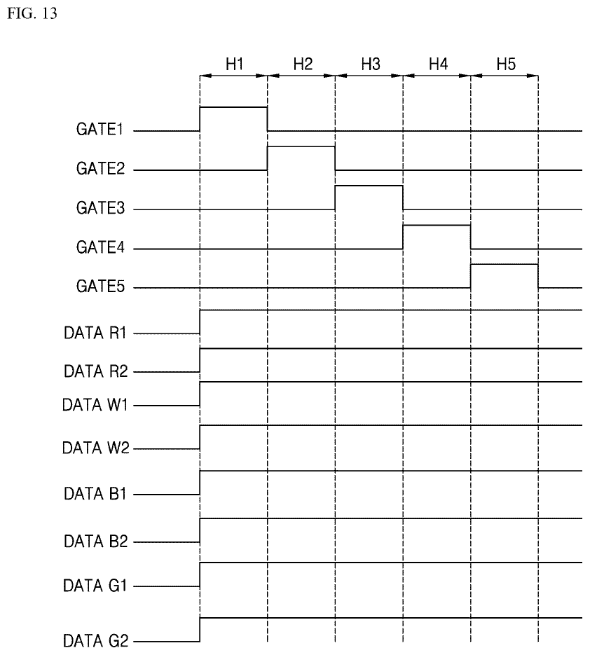

FIG. 13 is a timing diagram of a gate voltage and a data voltage when a display device according to an embodiment of the present disclosure displays a monochromatic still screen.

As illustrated in FIG. 13, the first gate voltage GATE1 is output via the first gate line GL1, the second gate voltage GATE2 is output via the second gate line GL2, the third gate voltage GATE3 is output via the third gate line GL3, the fourth gate voltage GATE4 is output via the fourth gate line GL4, and the fifth gate voltage GATE5 is output via the fifth gate line GL5.

In addition, the first data voltage DATA1 is output via the first data line DL1, the second data voltage DATA2 is output via the second data line DL2, the third data voltage DATA3 is output via the third data line DL3, the fourth data voltage DATA4 is output via the fourth data line DL4, and the fifth data voltage DATA5 is output via the fifth data line DL5.

As illustrated in FIG. 13, during the first horizontal period H1, the first gate voltage GATE1 is the gate high voltage, and the second gate voltage GATE2, the third gate voltage GATE3, the fourth gate voltage GATE4, and the fifth gate voltage GATE5 are the gate low voltages. In addition, during the first horizontal period H1, each of the first data voltage DATA1 to the fifth data voltage DATA5 can be a data voltage of a predetermined level for implementing a predetermined grayscale.

Accordingly, during the first horizontal period H1, all of the switching transistors respectively connected to the plurality of first sub-pixels R1, W1, B1, and G1 arranged in the first column and the plurality of fourth sub-pixels R2, W2, B2, and G2 arranged in the fourth column in the odd-numbered row odd are turned on.

Accordingly, during the first horizontal period H1, in the odd-numbered row odd, the data voltage DATA R1 can be charged into the first sub-pixels R1 and 711 arranged in the first column, the data voltage DATA R2 can be charged into the fourth sub-pixels R 2 and 714 arranged in the fourth column, the data voltage DATA W1 can be charged into the first sub-pixel W1 arranged in the first column, the data voltage DATA W2 can be charged into the fourth sub-pixel W2 arranged in the fourth column, the data voltage DATA B1 can be charged into the first sub-pixel B1 arranged in the first column, and the data voltage DATA B1 can be charged into the fourth sub-pixel B2 arranged in the fourth column. The data voltage DATA G1 can be charged into the first sub-pixel G1 arranged in the first column, and the data voltage DATA G2 can be charged into the fourth sub-pixel G2 arranged in the fourth column.

As illustrated in FIG. 13, during the second horizontal period H2, the second gate voltage GATE2 is the gate high voltage, and the first gate voltage GATE1, the third gate voltage GATE3, the fourth gate voltage GATE4, and the fifth gate voltage GATE5 are the gate low voltages. In addition, during the second horizontal period H2, each of the first data voltage DATA1 to the fifth data voltage DATA5 can be a data voltage of a predetermined level for implementing a predetermined grayscale.

Accordingly, during the second horizontal period H2, all of the switching transistors respectively connected to the plurality of third sub-pixels R1, W1, B1, and G1 arranged in the third column and the plurality of fifth sub-pixels R2, W2, B2, and G2 arranged in the fifth column in the odd-numbered row odd are turned on.

Accordingly, during the second horizontal period H2, in the odd-numbered row odd, the data voltage DATA R1 can be charged into the third sub-pixel R1 713 arranged in the third column, the data voltage DATA R2 can be charged into the fifth sub-pixel R2 715 arranged in the fifth column, the data voltage DATA W1 can be charged into the third sub-pixel W1 arranged in the third column, the data voltage DATA W2 can be charged into the fifth sub-pixel W2 arranged in the fifth column, the data voltage DATA B1 can be charged into the third sub-pixel B1 arranged in the third column, and the data voltage DATA B2 can be charged into the fifth sub-pixel B2 arranged in the fifth column. The data voltage DATA G1 can be charged into the third sub-pixel G1 arranged in the third column, and the data voltage DATA G2 can be charged into the fifth sub-pixel G2 arranged in the fifth column.

As illustrated in FIG. 13, during the third horizontal period H3, the third gate voltage GATE3 is the gate high voltage, and the first gate voltage GATE1, the second gate voltage GATE2, the fourth gate voltage GATE4, and the fifth gate voltage GATE5 are the gate low voltages. In addition, during the third horizontal period H3, each of the first data voltage DATA1 to the fifth data voltage DATA5 can be a data voltage of a predetermined level for implementing a predetermined grayscale.

Accordingly, during the third horizontal period H3, all of the switching transistors respectively connected to the plurality of second sub-pixels R1, W1, B1, and G1 arranged in the second column in the odd-numbered row odd and the plurality of fourth sub-pixels R2, W2, B2, and G2 arranged in the fourth column in the even-numbered row even are turned on.

Accordingly, during the third horizontal period H3, in the odd-numbered row odd, the data voltage DATA R1 can be charged into the second sub-pixels R1 and 712 arranged in the second column, the data voltage DATA R2 can be charged into the fourth sub-pixel R2 arranged in the fourth column in the even-numbered row even, the data voltage DATA W1 can be charged into the second sub-pixel W1 arranged in the second column in the odd-numbered row odd, the data voltage DATA W2 can be charged into the fourth sub-pixel W2 arranged in the fourth column in the even-numbered row even, and the data voltage DATA B1 can be charged into the second sub-pixel B1 arranged in the second column in the odd-numbered row odd The data voltage DATA B2 can be charged into the fourth sub-pixel B2 arranged in the fourth column in the even-numbered row even, the data voltage DATA G1 can be charged into the second sub-pixel G1 arranged in the second column in the odd-numbered row odd, and the data voltage DATA G2 can be charged into the fourth sub-pixel G2 arranged in the fourth column in the even-numbered row even.

As illustrated in FIG. 13, in the fourth horizontal period H4, the fourth gate voltage GATE4 is the gate high voltage, and the first gate voltage GATE1, the second gate voltage GATE2, the third gate voltage GATE3, and the fifth gate voltage GATE5 are the gate low voltages. In addition, in the fourth horizontal period H4, each of the first data voltage DATA1 to the fifth data voltage DATA5 can be a data voltage of a predetermined level for implementing a predetermined gray scale.

Accordingly, during the fourth horizontal period H4, all of the switching transistors respectively connected to the plurality of first sub-pixels R1, W1, B1, and G1 arranged in the first column and the plurality of third sub-pixels R2, W2, B2, and G2 arranged in the third column in the even-numbered row even are turned on.

Accordingly, during the fourth horizontal period H4, in the even-numbered row even, the data voltage DATA R1 can be charged into the first sub-pixels R1 and 721 arranged in the first column, the data voltage DATA R2 can be charged into the third sub-pixels R2 and 723 arranged in the third column, the data voltage DATA W1 can be charged into the first sub-pixel W1 arranged in the first column, the data voltage DATA W2 can be charged into the third sub-pixel W2 arranged in the third column, the data voltage DATA B1 can be charged into the first sub-pixel B1 arranged in the first column, and the data voltage DATA B1 can be charged into the third sub-pixel B2 arranged in the third column. The data voltage DATA G1 can be charged into the first sub-pixel G1 arranged in the first column, and the data voltage DATA G2 can be charged into the third sub-pixel G2 arranged in the third column.

As illustrated in FIG. 13, during the fifth horizontal period H5, the fifth gate voltage GATE5 is the gate high voltage, and the first gate voltage GATE1, the second gate voltage GATE2, the third gate voltage GATE3, and the fourth gate voltage GATE4 are the gate low voltages. During the fifth horizontal period H5, each of the first data voltage DATA1 to the fifth data voltage DATA5 can be a data voltage of a predetermined level for implementing a predetermined grayscale.

Accordingly, during the fifth horizontal period H5, all of the switching transistors respectively connected to the plurality of second sub-pixels R1, W1, B1, and G1 arranged in the second column and the plurality of fifth sub-pixels R2, W2, B2, and G2 arranged in the fifth column in the even-numbered row even are turned on.

Accordingly, during the fifth horizontal period H5, in the even-numbered row even, the data voltage DATA R1 can be charged into the second sub-pixels R1 and 722 arranged in the second column, the data voltage DATA R2 can be charged into the fifth sub-pixels R2 and 725 arranged in the fifth column, the data voltage DATA W1 can be charged into the second sub-pixel W1 arranged in the second column, the data voltage DATA W2 can be charged into the fifth sub-pixel W2 arranged in the fifth column, the data voltage DATA B1 can be charged into the second sub-pixel B1 arranged in the second column, and the data voltage DATA B2 can be charged into the fifth sub-pixel B2 arranged in the fifth column. The data voltage DATA G1 can be charged into the second sub-pixel G1 arranged in the second column, and the data voltage DATA G2 can be charged into the fifth sub-pixel G2 arranged in the fifth column.

As described above, when the display device 100 according to an embodiment of the present disclosure displays a monochromatic still screen, each of the first data voltage to the fifth data voltage VDATA1 to VDATA5 can have the same level during the first horizontal period to the fifth horizontal period H1 to H5, that is, during one frame. Accordingly, each of the first data voltage to the fifth data voltage is not subjected to the data voltage change (data transition) during one frame.

In other words, the display device 100 can use a five-period driving sequence (H1-H5) to display a monochromatic still screen. During each period, a corresponding gate line (GL1-GL5) is sequentially pulsed high which activates and charges a different set of sub-pixels across the panel. Because the image is a single, unchanging color, the data voltages supplied to the sub-pixels remain constant throughout all five periods. This method can eliminate any data voltage changes or data transitions for the entire duration of the frame.

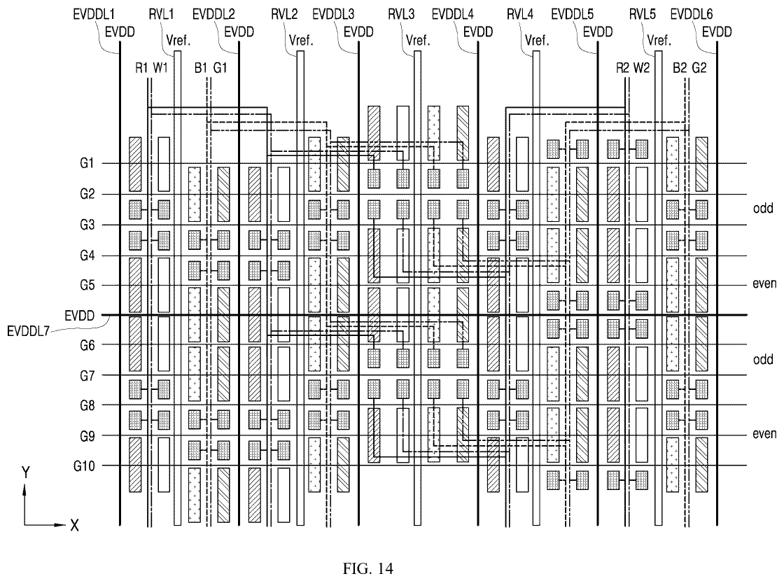

FIG. 14 is an example diagram illustrating a state in which each of a plurality of data lines divides into a plurality of sub-data lines and each of the sub-data lines is connected to one sub-pixel in a display panel according to an embodiment of the present disclosure.

Referring to FIG. 14, in the display panel according to an embodiment of the present disclosure, each of the plurality of data lines can divide into a plurality of sub-data lines, and each of the sub-data lines can be connected to one sub-pixel. In addition, each sub-pixel can include a light-emitting area and a driving circuit that drives the light-emitting area to emit light.

The display panel according to an embodiment of the present disclosure can drive five pixels arranged in the same row using two data lines.

According to an embodiment, a plurality of pixels are arranged in each row.

For example, a first pixel can be disposed in the first row odd, and the first pixel can include a plurality of sub-pixels R₁₁, W₁₁, B₁₁, and G₁₁. In addition, a second pixel can be disposed at a position adjacent to (e.g., on a right side of) the first pixel, and the second pixel can include a plurality of sub-pixels R₁₂, W₁₂, B₁₂, and G₁₂. A third pixel can be disposed at a position adjacent to (e.g., on a right side of) the second pixel, and the third pixel can include a plurality of sub-pixels R₁₃, W₁₄, B₁₃, and G₁₃. A fourth pixel can be disposed at a position adjacent to (e.g., on a right side of) the third pixel, and the fourth pixel can include a plurality of sub-pixels R₁₄, W₁₄, B₁₄, and G₁₄. Labels R₁₁ through G₁₄ are omitted from FIG. 14 to improve clarity and for ease of explanation.

According to an embodiment, each sub-pixel can include a light-emitting area and a driving circuit for driving the light-emitting area to emit light.

According to an embodiment, the driving circuit of each of the sub-pixels R₁₁, W₁₁, B₁₁, and G₁₁ of the first pixel disposed in the first row odd can be disposed on one of both opposing sides in the column direction of a corresponding light-emitting area. In addition, the driving circuit of each of the sub-pixels R₁₂, W₁₂, B₁₂, and G₁₂ of the second pixel disposed in the first row odd can be disposed on one of both opposing sides in the column direction of a corresponding light-emitting area. In addition, the driving circuit of each of the sub-pixels R₁₃, W₁₄, B₁₃, and G₁₃ of the third pixel disposed in the first row odd can be disposed on one of both opposing sides in the column direction of a corresponding light-emitting area. For example, diving circuits for the sub-pixels of the first, second and third pixels within the first odd-numbered row can all be disposed on the same side (e.g., at the lower side) of their respective light-emitting areas.

On the other hand, the driving circuit of each of the sub-pixels R₁₄ and W₁₄ of the fourth pixel disposed in the first row odd can be disposed on the other of both opposing sides in the column direction of the corresponding light-emitting area, whereas the driving circuit of each of the sub-pixels B₁₄ and G₁₄ of the fourth pixel can be disposed on one of both opposing sides in the column direction of a corresponding light-emitting area. In other words, in contrast to the diving circuits for the sub-pixels of the first, second and third pixels within the first odd-numbered row, the driving circuits for the fourth pixel's sub-pixels can be split up by location, e.g., the circuits for the R₁₄ and W₁₄ sub-pixels are on one side of the light-emitting area (e.g., lower side), while the circuits for the B₁₄ and G₁₄ sub-pixels are on the opposite side (e.g., upper side).

In addition, the driving circuit of each of the sub-pixels R₁₅ and W₁₅ of the fifth pixel disposed in the first row odd can be disposed on one of both opposing sides in the column direction of a corresponding light-emitting area, whereas the driving circuit of each of the sub-pixels B₁₅ and G₁₅ of the fifth pixel can be disposed on the other of both opposing sides in the column direction of a corresponding light-emitting area. For example, the driving circuits for the fifth pixel's sub-pixels can be split up by location the other way compared to the fourth pixel, e.g., the circuits for the R₁₅ and W₁₅ sub-pixels are on one side of the light-emitting area (e.g., upper side), while the circuits for the B₁₅ and G₁₅ sub-pixels are on the opposite side (e.g., lower side).

As described above, in all the sub-pixels R₁₁, W₁₁, B₁₁, G₁₁, R₁₂, W₁₂, B₁₂, G₁₂, R₁₃, W₁₄, B₁₃, and G₁₃ of the first pixel to the third pixel disposed in the first row, the driving circuit is disposed on the other of both opposing sides in the column direction of the light-emitting area, whereas in the sub-pixels R₁₄ and W₁₄ as some of the sub-pixels of the fourth pixel, the driving circuit is disposed on the other of both opposing sides in the column direction of the light-emitting area, and in the sub-pixels B₁₄ and G₁₄ as the others of the sub-pixels of the fourth pixel, the driving circuit is disposed on one of both opposing sides in the column direction of the light-emitting area. In addition, in some sub-pixels R₁₅ and W₁₅ of the sub-pixels of the fifth pixel, the driving circuit is disposed on one of both opposing sides in the column direction of the light-emitting area, while the driving circuit is disposed on the other of both opposing sides in the column direction of the light-emitting area in the sub-pixels B₁₅ and G₁₅ as the others of the sub-pixels of the fifth pixel.

According to an embodiment, in the pixels PX arranged in the first row of the display panel 110 of the present disclosure, the above-described arrangement of the light-emitting areas and the driving circuits of the sub-pixels can be repeated every five pixels PX.

According to an embodiment, the sub-pixels R₂₁, W₂₁, B₂₁, and G₂₁ of the first pixel can be disposed in the second row even. The sub-pixels R₂₂, W₂₂, B₂₂, and G₂₂ of the second pixel can be disposed at a position adjacent to (e.g., on the right side of) the first pixel including the sub-pixels R₂₁, W₂₁, B₂₁, and G₂₁. The sub-pixels B₂₃, G₂₃, R₂₃, and W₂₃ of the third pixel can be disposed at a position adjacent to (e.g., on the right side of) the second pixel including the sub-pixels R₂₂, W₂₂, B₂₃, and G₂₃. The sub-pixels B₂₄, G₂₄, R₂₅, and W₂₄ of the fourth pixel can be disposed at a position adjacent to (e.g., on the right side of) the third pixel including the sub-pixels B₂₃, G₂₃, R₂₃, and W₂₃. The sub-pixels B₂₅, G₂₅, R₂₅, and W₂₅ of the fifth pixel can be disposed at a position adjacent to (e.g., on the right side of) the fourth pixel including the sub-pixels B₂₄, G₂₄, R₂₄, and W₂₄.

According to an embodiment, the driving circuit of each of the sub-pixels R₂₁, W₂₁, B₂₁, and G₂₁ of the first pixel disposed in the second row even can be disposed on one of both opposing sides in the column direction of a corresponding light-emitting area. In addition, the driving circuit of each of the sub-pixels R₂₂, W₂₂, B₂₂, and G₂₂ of the second pixel disposed in the second row even can be disposed on one of both opposing sides in the column direction of a corresponding light-emitting area. In addition, the driving circuit of each of the sub-pixels R₂₃, W₂₃, B₂₃, and G₂₃ of the third pixel disposed in the second row even can be disposed on one of both opposing sides in the column direction of a corresponding light-emitting area. For example, diving circuits for the sub-pixels of the first, second and third pixels within the second even-numbered row can all be disposed on the same side (e.g., at the upper side) of their respective light-emitting areas.

On the other hand, the driving circuit of each of the sub-pixels R₂₄ and W₂₄ of the fourth pixel disposed in the second row even are disposed on one of both opposing sides in the column direction of a corresponding light-emitting area, whereas the driving circuit of each of the sub-pixels B₂₄ and G₂₄ of the fourth pixel can be disposed on the other of both opposing sides in the column direction of a corresponding light-emitting area. In other words, in contrast to the diving circuits for the sub-pixels of the first, second and third pixels within the second even-numbered row, the driving circuits for the fourth pixel's sub-pixels can be split up by location, e.g., the circuits for the R₂₄ and W₂₄ sub-pixels are on one side of the light-emitting area (e.g., upper side), while the circuits for the B₂₄ and G₂₄ sub-pixels are on the opposite side (e.g., lower side).

In addition, the driving circuit of each of the sub-pixels R₂₅ and W₂₅ of the fifth pixel disposed in the second row even are disposed on the other of both opposing side in the column direction of a corresponding light-emitting area, whereas the driving circuit of each of the sub-pixels B₂₅ and G₂₅ of the fifth pixel can be disposed on one of both opposing side in the column direction of a corresponding light-emitting area. For example, the driving circuits for the fifth pixel's sub-pixels in the second row can be split up by location the other way compared to the fourth pixel of the second row, e.g., the circuits for the R25 and W25 sub-pixels are on one side of the light-emitting area (e.g., lower side), while the circuits for the B25 and G25 sub-pixels are on the opposite side (e.g., upper side) as shown in FIG. 14.

As described above, in each of all the sub-pixels R₂₁, W₂₁, B₂₁, G₂₁, R₂₂, W₂₂, B₂₂, G₂₂, R₂₃, W₂₃, B₂₃, and G₂₃ of the first pixel to the third pixel disposed in the second row, the driving circuit is disposed on one of both opposing sides in the column direction of the corresponding light-emitting area. In each of the sub-pixels R₂₄ and W₂₄ as some of the sub-pixels of the fourth pixel, the driving circuit is disposed on one of both opposing sides in the column direction of the corresponding light-emitting area, while in each of the sub-pixels B₂₄ and G₂₄ as the others of the sub-pixels of the fourth pixel, the driving circuit is disposed on the other of both opposing sides in the column direction of the corresponding light-emitting area. In addition, in each of the sub-pixels R₂₅ and W₂₅ as some of the sub-pixels of the fifth pixel the driving circuit is disposed on the other of both opposing sides in the column direction of the corresponding light-emitting area, while the driving circuit is disposed on one of both opposing sides in the column direction of the corresponding light-emitting area in each of the sub-pixels B₂₅ and G₂₅ as the other of the sub-pixels of the fifth pixel.

According to an embodiment, in the pixels PX disposed in the second row of the display panel 110 of the present disclosure, the above-described arrangement of the light-emitting areas and the driving circuits of the sub-pixels is repeated every five pixels PX.

According to an embodiment, in the display panel 110 of the present disclosure, the arrangement of the light-emitting areas and the driving circuits of the sub-pixels as above-described with reference to the first row can be equally applied to the arrangement of the light-emitting areas and the driving circuits of the sub-pixels of the third row, and so on for every odd-numbered row. In addition, in the display panel 110, the arrangement of the light-emitting areas and the driving circuits of the sub-pixels as above-described with reference to the second row can be equally applied to the arrangement of the light-emitting areas and the driving circuits of the sub-pixels of the fourth row, and so on for every even-numbered row. In this way, in the display panel 110 of the present disclosure, the arrangements of the light-emitting areas and the driving circuits of the sub-pixels of each pixel can be alternately arranged with each other every two rows.

According to an embodiment, each of the plurality of high potential voltage lines EVDDL can be disposed between adjacent ones of the plurality of pixels PX.

For example, the first high potential voltage line EVDDL1 can be disposed on a side (e.g., a left side) of the first pixel disposed in the first column, the second high potential voltage line EVDDL2 can be disposed between the first pixel disposed in the first column and the second pixel disposed in the second column, and the third high potential voltage line EVDDL3 can be disposed between the second pixel disposed in the second column and the third pixel disposed in the third column.

Similarly, the fourth high potential voltage line EVDDL4 can be disposed between the third pixel disposed in the third column and the fourth pixel disposed in the fourth column, the fifth high potential voltage line EVDDL5 can be disposed between the fourth pixel disposed in the fourth column and the fifth pixel disposed in the fifth column, and the sixth high potential voltage line EVDDL6 can be disposed on one side (e.g., the right side) of the fifth pixel disposed in the fifth column. For example, each pixel can be disposed between two high potential voltage lines.

As described above, each of the plurality of high potential voltage lines EVDDL can be disposed between adjacent ones of the pixels PX, and each of the plurality of high potential voltage lines EVDDL can extend in a direction (e.g., the second direction or the Y-axis direction) parallel to the column direction in which the pixels are arranged.

According to an embodiment, the display panel 110 of the present disclosure can include an additional high potential voltage line EVDDL7 extending in a direction (e.g., the first direction or the X-axis direction or the row direction) perpendicular to the extension direction (the second direction) of each of the plurality of high-potential voltage lines EVDDL1 to EVDDL6.

One additional high potential voltage line EVDDL7 can be present every two rows of the pixels. For example, the additional high potential voltage line EVDDL7 can be disposed between the second row and the third row of the pixels. For example, an extra high potential voltage line can be disposed between two rows of pixels and extend horizontally, rather than in the vertical direction.

Since the additional high potential voltage line EVDDL7 is present every two rows of the pixels, the visibility can be improved and a situation in which the gate line is absent in the pixel can be prevented. In addition, the additional high potential voltage line EVDDL7 is present every two rows of the pixels such that an aperture ratio deviation can be resolved and the aperture ratio can be equalized.

In order to equalize the aperture ratio, the display panel 110 according to the present disclosure can have a mesh structure in which the additional high potential voltage lines EVDDL7 and the plurality of high potential voltage lines EVDDL1 to EVDDL6 intersect each other in the plan view. In other words, to equalize the aperture ratio across the pixels and make the arrangement appear more uniform, the display panel features a mesh structure of high potential voltage lines. This is created by adding an additional voltage line every two pixel rows that intersects with the existing ones that extend between the pixels in the vertical direction. This mesh design improves visual consistency and prevents potential wiring gaps in the pixel layout.

According to an embodiment, each of the plurality of reference voltage lines RVL can be disposed inside one pixel PX. For example, each reference voltage line can extend across or overlap with the center of a corresponding pixel in the vertical direction.

For example, the first reference voltage line RVL1 can be disposed inside the first pixel disposed in the first column (e.g., between the second sub-pixel W and the third sub-pixel B), the second reference voltage line RVL2 can be disposed inside the second pixel disposed in the second column (e.g., between the second sub-pixel W and the third sub-pixel B), and the third reference voltage line RVL3 can be disposed inside the first pixel disposed in the third column (e.g., between the second sub-pixel W and the third sub-pixel B).

Similarly, the fourth reference voltage line RVL4 can be disposed inside the fourth pixel disposed in the fourth column (e.g., between the second sub-pixel W and the third sub-pixel B), and the fifth reference voltage line RVL5 can be disposed inside the fifth pixel disposed in the fifth column (e.g., between the second sub-pixel W and the third sub-pixel B).

As described above, each of the plurality of reference voltage lines RVL can be disposed inside the pixel PX, and the plurality of reference voltage lines RVL1 to RVL5 can extend in a direction (e.g., the second direction or the Y-axis direction) parallel to the column direction in which the pixels are arranged.

According to an embodiment, in the display panel 110 of the present disclosure, one data line DL can divide into a plurality of sub-data lines SDL. In addition, each sub-data line SDL can be electrically connected to a driving circuit of each of the sub-pixels emitting light of the same color arranged in the same row and apply a data voltage thereto.

Hereinafter, driving of the sub-pixel SP in a state in which one data line DL divides into a plurality of sub-data lines will be described.

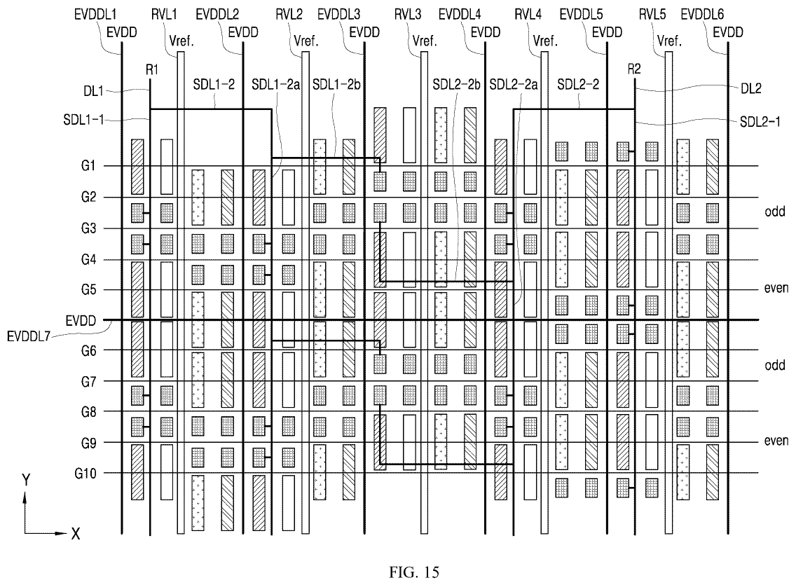

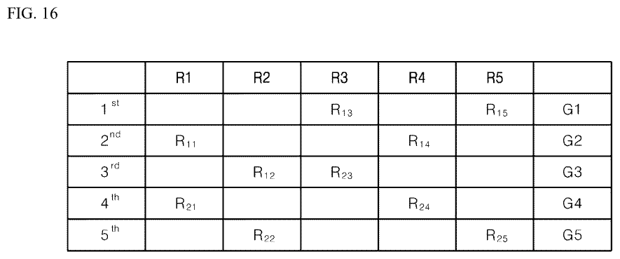

FIG. 15 is an example diagram illustrating a state in which each of a first data line and a second data line divides into a plurality of sub-data lines, and each of the sub-data lines is connected to a first sub-pixel (e.g., the red sub-pixels) of each pixel in a display panel according to an embodiment of the present disclosure. FIG. 16 is an example diagram illustrating a driving scheme of a first sub-pixel (e.g., the red sub-pixels) using the plurality of sub-data lines into which each of the first data line and the second data line divides according to FIG. 15.

In FIG. 15, the arrangement of the pixels PX, the arrangement of the sub-pixels, the arrangement of the light-emitting area and the driving circuit of each sub-pixel, and the arrangement of the reference voltage lines RVL, the high potential voltage lines, and the additional high potential voltage line are respectively the same as the arrangement of the pixels PX, the arrangement of the sub-pixels, the arrangement of the light-emitting area and the driving circuit of each sub-pixel, and the arrangement of the reference voltage lines RVL, the high potential voltage lines, and the additional high potential voltage line in FIG. 14. Therefore, in FIG. 15, a description of each of the arrangement of the pixels PX, the arrangement of the sub-pixels, the arrangement of the light-emitting area and the driving circuit of each sub-pixel, and the arrangement of the reference voltage lines RVL, the high potential voltage lines, and the additional high potential voltage line will be omitted.

Referring to FIG. 15, the display panel 110 can drive each of the first sub-pixel R11 of the first pixel, the first sub-pixel R₁₂ of the second pixel, the first sub-pixel R₁₃ of the third pixel, the first sub-pixel R₁₄ of the fourth pixel, and the first sub-pixel R₁₅ of the fifth pixel disposed in the first row, and the first sub-pixel R₂₁ of the first pixel, the first sub-pixel R₂₂ of the second pixel, the first sub-pixel R₂₃ of the third pixel, the first sub-pixel R₂₄ of the fourth pixel, and the first sub-pixel R₂₅ of the fifth pixel disposed in the second row.

To this end, the first data line DL1 divides into two sub-data lines SDL1-1 and SDL1-2, and the second sub-data line SDL1-2 divides into two sub-data lines SDL1-2a and SDL1-2b. As such, the first data line DL1 divides into three sub-data lines SDL1-1, SDL1-2a, and SDL1-2b.

In addition, the second data line DL2 divides into two sub-data lines SDL2-1 and SDL2-2, and the first sub-data line SDL2-2 divides into two sub-data lines SDL2-2a and SDL2-2b again. As such, the second data line DL2 divides into three sub-data lines SDL2-1, SDL2-2a, and SDL2-2b.

According to an embodiment, the sub-data line SDL1-1 into which the first data line DL1 divides is connected to each of the driving circuit of the first sub-pixel R₁₁ of the first pixel disposed in the first row and the driving circuit of the first sub-pixel R₂₁ of the first pixel disposed in the second row to drive the light-emitting area of each of thereof. Further, the sub-data line SDL1-2a in which the first data line DL1 divides is connected to the driving circuit of each of the first sub-pixel R₁₂ of the second pixel disposed in the first row and the first sub-pixel R₂₂ of the second pixel disposed in the second row to drive the light-emitting area of each thereof. In addition, the sub-data line SDL1-2b in which the first data line DL1 divides is connected to the driving circuit of the first sub-pixel R₁₃ of the third pixel disposed in the first row to drive the light-emitting area thereof.

In addition, the sub-data line SDL2-1 in which the second data line DL2 divides is connected to the driving circuit of the first sub-pixel R₁₅ of the fifth pixel disposed in the first row and the first sub-pixel R₂₅ of the fifth pixel disposed in the second row to drive the light-emitting area of each thereof. Further, the sub-data line SDL2-2a in which the second data line DL2 divides is connected to the driving circuit of the first sub-pixel R₁₄ of the fourth pixel disposed in the first row and the first sub-pixel R₂₄ of the fourth pixel disposed in the second row to drive the light-emitting area of each thereof. In addition, the sub-data line SDL2-2b in which the second data line DL2 divides is connected to the driving circuit of the first sub-pixel R₂₃ of the third pixel disposed in the second row to drive the light-emitting area thereof.

As described above, each of the sub-data lines SDL is connected to the driving circuit of each of the sub-pixels emitting light of the same color arranged in one row and applies the data voltage to the driving circuit.

Using the red sub-pixels in the first row as an example, as shown in FIG. 15, the display panel drives five columns of same-colored sub-pixels (e.g., red) using two data lines (DL1/R1, and DL2/R2). To achieve this, each of the two data lines asymmetrically branches into three sub-data lines or two sub-data lines. The three branches (SDL1-1, SDL1-2a, SDL1-2b) from the first data line (D1/R1) are coupled to the red sub-pixels in the first, second and third columns. Also, the two branches (SDL2-1, SDL2A) from the second data line (DL2) are coupled to red sub-pixels in the fourth and fifth columns. Also, the branching pattern flips for the next row (e.g., the second row), in which the first data line (DL1/R1) has two branches (SDL1-1, SDL1-2a) and the second data line (DL2) has three branches (SDL2-2b, SDL2-2a, SDL2-1). This configuration allows the two data lines to share control of the central third column, in an alternating manner for every other row of pixels.

According to an embodiment, the arrangement structure of the sub-data lines connected to the sub-pixels disposed in the first row and the sub-pixels disposed in the second row as described above is equally applied to the arrangement structure of the sub-data lines connected to the sub-pixels disposed in the third row and the fourth row disposed on the other of both opposing sides in the column direction of the second row, and so on for the even and odd numbered rows.

According to an embodiment, the additional high potential voltage line EVDDL7 can be disposed between the second row and the third row to equalize the aperture ratio of the pixels. The additional high potential voltage line EVDDL7 extends in a parallel manner to the plurality of gate lines GL, and is disposed every five gate lines among the plurality of gate lines GL.

Referring to FIG. 16, the first gate line G1 is disposed between the light-emitting area and the driving circuit of each of the first sub-pixel to the fourth sub-pixel R₁₃, W₁₄, B₁₃, and G₁₃ of the third pixel disposed in the first row, between the driving circuit and the light-emitting area of each of the third sub-pixel B₁₄ and the fourth sub-pixel G₁₄ of the fourth pixel disposed in the first row, and between the driving circuit and the light-emitting area of each of the first sub-pixel R₁₅ and the second sub-pixel W₁₅ of the first row.

For example, when the gate signal is applied via the first gate line G1, the first sub-pixel R₁₃ of the third pixel and the first sub-pixel R₁₅ of the fifth pixel disposed in the first row emit light.

According to an embodiment, the second gate line G2 is disposed between the light-emitting area and the driving circuit of each of the first sub-pixel R₁₁ and the second sub-pixel W₁₁ of the first row, between the driving circuit and the light-emitting area of each of the third sub-pixel B₁₂ and the fourth sub-pixel G₁₂ of the first row, between the light-emitting area and the driving circuit of each of the fourth sub-pixel R₁₄ and the second sub-pixel W₁₄ of the first row, between the light-emitting area and the driving circuit of each of the fifth sub-pixel B₁₅ and the fourth sub-pixel G₁₅ of the first row, and between the light-emitting area and the driving circuit of each of the third sub-pixel B₁₅ and the fourth sub-pixel G₁₅ of the first row.

For example, when the gate signal is applied via the second gate line G2, the first sub-pixel R₁₁ of the first pixel and the first sub-pixel R₁₄ of the fourth pixel disposed in the first row emit light.

According to an embodiment, the third gate line G3 is disposed between the light-emitting area and the driving circuit of each of the third sub-pixel B₁₃ and the fourth sub-pixel G₁₄ of the first pixel in the first row, between the driving circuit and the light-emitting area of each of the first sub-pixel R₁₂ and the second sub-pixel W₁₂ of the first row, and between the driving circuit and the light-emitting area of each of the first sub-pixel to the fourth sub-pixel R₂₃, W₂₃, B₂₃, and G₂₃ of the third pixel in the second row.

For example, when the gate signal is applied via the third gate line G3, the first sub-pixel R₁₂ of the second pixel disposed in the first row and the first sub-pixel R₂₃ of the third pixel disposed in the second row emit light.

According to an embodiment, the fourth gate line G4 is disposed between the light-emitting area and the driving circuit of each of the first sub-pixel R₂₁ and the second sub-pixel W₂₁ of the second row, between the driving circuit and the light-emitting area of each of the third sub-pixel B₂₂ and the fourth sub-pixel G₂₂ of the second row, between the driving circuit and the light-emitting area of each of the first sub-pixel R₂₄ and the second sub-pixel W24 of the second row, and between the light-emitting area and the driving circuit of each of the third sub-pixel B₂₅ and the fourth sub-pixel G₂₅ of the second row.

For example, when the gate signal is applied via the fourth gate line G4, the first sub-pixel R₂₁ of the first pixel disposed in the second row and the first sub-pixel R₂₄ of the fourth pixel disposed in the second row emit light.

According to an embodiment, the fifth gate line G5 is disposed between the light-emitting area and the driving circuit of each of the third sub-pixel B₂₁ and the fourth sub-pixel G₂₁ of the second row, between the driving circuit and the light-emitting area of each of the first sub-pixel R₂₂ and the second sub-pixel W₂₂ of the second row, between the driving circuit and the light-emitting area of each of the third sub-pixel B₂₄ and the fourth sub-pixel G₂₄ of the second row, and between the light-emitting area and the driving circuit of each of the first sub-pixel R₂₅ and the second sub-pixel W₂₅ of the second row.

For example, when the gate signal is applied via the fifth gate line G5, the first sub-pixel R₂₂ of the second pixel disposed in the second row and the first sub-pixel R₂₅ of the fifth pixel disposed in the second row emit light.

Accordingly, when the gate signal is applied via the first gate line G1, the first sub-pixel R₁₃ of the third pixel in the first row and the first sub-pixel R₁₅ of the fifth pixel emit light, and when the gate signal is applied via the second gate line G2, the first sub-pixel R₁₁ of the first pixel in the first row and the first sub-pixel R₁₄ of the fourth pixel emit light.

In addition, when the gate signal is applied via the third gate line G3, the first sub-pixel R₁₂ of the second pixel of the first row and the first sub-pixel R₂₃ of the third pixel of the second row emit light, and when the gate signal is applied via the fourth gate line G4, the first sub-pixel R₂₁ of the first pixel of the second row and the first sub-pixel R₂₄ of the fourth pixel emit light.

When the gate signal is applied via the fifth gate line G5, the first sub-pixel R₂₂ of the second pixel of the second row and the first sub-pixel R₂₅ of the fifth pixel emit light.

For example, the five gate lines G1-G5 are intricately routed between the sub-pixels light-emitting areas and driving circuits. This specific layout allows each gate line to simultaneously activate a distinct pair of red sub-pixels, which can be in the same or different rows. By applying a gate signal sequentially from G1 to G5, the panel illuminates the following pairs of sub-pixels in order R₁₃ and R₁₅, then R₁₁ and R₁₄, then R₁₂ and R₂₃, then R₂₁ and R₂₄, and finally R₂₂ and R₂₅.

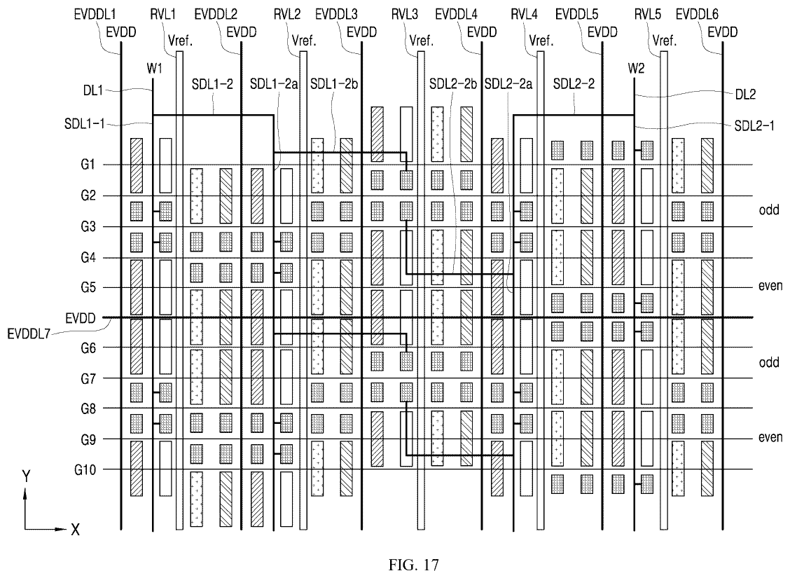

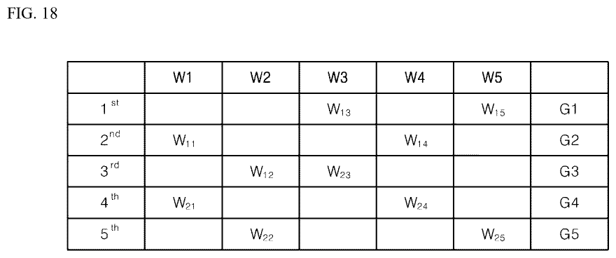

FIG. 17 is an example diagram illustrating a state in which each of a first data line and a second data line divides into a plurality of sub-data lines and each of the sub-data lines is connected to a second sub-pixel (e.g., the white subpixels) of each pixel in a display panel according to an embodiment of the present disclosure. FIG. 18 is an example diagram illustrating a driving scheme of a second sub-pixel (e.g., the white subpixels) using the plurality of sub-data lines into which each of the first data line and the second data line divides according to FIG. 17.

In FIG. 17, the arrangement of the pixels PX, the arrangement of the sub-pixels, the arrangement of the light-emitting area and the driving circuit of each sub-pixel, and the arrangement of the reference voltage lines RVL, the high potential voltage lines, and the additional high potential voltage line are respectively the same as the arrangement of the pixels PX, the arrangement of the sub-pixels, the arrangement of the light-emitting area and the driving circuit of each sub-pixel, and the arrangement of the reference voltage lines RVL, the high potential voltage lines, and the additional high potential voltage line in FIG. 14. Therefore, in FIG. 17, a description of each of the arrangement of the pixels PX, the arrangement of the sub-pixels, the arrangement of the light-emitting area and the driving circuit of each sub-pixel, and the arrangement of the reference voltage lines RVL, the high potential voltage lines, and the additional high potential voltage line will be omitted.

Referring to FIG. 17, the display panel 110 can drive each of the second sub-pixel W₁₁ of the first pixel, the second sub-pixel W₁₂ of the second pixel, the second sub-pixel W₁₃ of the third pixel, the second sub-pixel W₁₄ of the fourth pixel, and the second sub-pixel W₁₅ of the fifth pixel disposed in the first row, and the second sub-pixel W₂₁ of the second pixel, the second sub-pixel W₂₂ of the second pixel, the second sub-pixel W₂₃ of the third pixel, the second sub-pixel W₂₄ of the fourth pixel, and the second sub-pixel W₂₅ of the fifth pixel in the disposed in the second row.

To this end, the first data line DL1 divides into two sub-data lines SDL1-1 and SDL1-2, and the second sub-data line SDL1-2 divides into two sub-data lines SDL1-2a and SDL1-2b. As such, the first data line DL1 divides into three sub-data lines SDL1-1, SDL1-2a, and SDL1-2b.

In addition, the second data line DL2 divides into two sub-data lines SDL2-1 and SDL2-2, and the first sub-data line SDL2-2 divides into two sub-data lines SDL2-2a and SDL2-2b again. As such, the first data line DL2 divides into three sub-data lines SDL2-1, SDL2-2a, and SDL2-2b.

According to an embodiment, the sub-data line SDL1-1 in which the first data line DL1 divides is connected to the driving circuit of the second sub-pixel W₁₁ of the first pixel disposed in the first row and the driving circuit of the second sub-pixel W₂₁ of the first pixel disposed in the second row to drive the light-emitting area of each thereof. Further, the sub-data line SDL1-2a in which the first data line DL1 divides is connected to the driving circuit of the second sub-pixel W₁₂ of the second pixel disposed in the first row and the driving circuit of the second sub-pixel W₂₂ of the second pixel disposed in the second row to drive the light-emitting area of each thereof. In addition, the sub-data line SDL1-2b in which the first data line DL1 divides is connected to the driving circuit of the second sub-pixel W₁₃ of the third pixel disposed in the first row to drive the light-emitting area of each thereof.

In addition, the sub-data line SDL2-1 in which the second data line DL2 divides is connected to the driving circuit of the second sub-pixel W₁₅ of the fifth pixel disposed in the first row and the second sub-pixel W₂₅ of the fifth pixel disposed in the second row to drive the light-emitting area of each thereof. Further, the sub-data line SDL2-2a in which the second data line DL2 divides is connected to the driving circuit of the second sub-pixel W₁₄ of the fourth pixel disposed in the first row and the driving circuit of the second sub-pixel W₂₄ of the fourth pixel disposed in the second row to drive the light-emitting area of each thereof. The sub-data line SDL2-2b in which the second data line DL2 divides is connected to the driving circuit of the second sub-pixel W₂₃ of the third pixel disposed in the second row to drive the light-emitting area thereof.

For example, referring to FIG. 17, the panel drives the white (W) sub-pixels using the same two-line, five-column architecture. Each of the two data lines DL1, DL2 asymmetrically branches into three sub-data lines or two sub-data lines. For example, the three branches from the first data line DL1 are coupled to the W sub-pixels in the first two columns and the first-row sub-pixel of the third column. Correspondingly, the three branches from the second data line DL2 are coupled to the W sub-pixels in the fourth and fifth columns and the second-row sub-pixel of the third column, allowing the two main data lines to share/alternate control of the central column (e.g., the third column).

As described above, each of the sub-data lines SDL is connected to the driving circuit of each of the sub-pixels emitting light of the same color arranged in one row to apply the data voltage to the driving circuit.

According to an embodiment, the arrangement structure of the sub-data lines respectively connected to the sub-pixels disposed in the first row and the sub-pixels disposed in the second row as described above is equally applied to the arrangement structure of the sub-data lines respectively connected to the sub-pixels disposed in the third row and the fourth row disposed on the other (on the lower side in the drawing) of both opposing side in the column direction of the second row.

According to an embodiment, the additional high potential voltage line EVDDL7 can be disposed between the second row and the third row to equalize the aperture ratio of the pixels. The additional high potential voltage line EVDDL7 extends in a parallel manner to the plurality of gate lines GL, and one additional high potential voltage line EVDDL7 is disposed every five gate lines among the plurality of gate lines GL.

Since the positions of the gate lines GL illustrated in FIG. 17 are the same as those of FIG. 15, a description thereof will be omitted.

For example, when the gate signal is applied via the first gate line G1, the second sub-pixel W₁₃ of the third pixel disposed in the first row and the second sub-pixel W₁₅ of the fifth pixel emit light.

For example, when the gate signal is applied via the second gate line G2, the second sub-pixel W₁₁ of the first pixel disposed in the first row and the second sub-pixel W₁₄ of the fourth pixel emit light.

For example, when the gate signal is applied via the third gate line G3, the second sub-pixel W₁₂ of the second pixel disposed in the first row and the second sub-pixel W₂₃ of the third pixel disposed in the second row emit light.

For example, when the gate signal is applied via the fourth gate line G4, the second sub-pixel W₂₁ of the first pixel disposed in the second row and the second sub-pixel W₂₄ of the fourth pixel disposed in the second row emit light.

For example, when the gate signal is applied via the fifth gate line G5, the second sub-pixel W₂₂ of the second pixel disposed in the second row and the second sub-pixel W₂₅ of the fifth pixel disposed in the second row emit light.

Accordingly, when the gate signal is applied via the first gate line G1, the second sub-pixel W₁₃ of the third pixel of the first row and the second sub-pixel W₁₅ of the fifth pixel of the first row emit light, and when the gate signal is applied via the second gate line G2, the second sub-pixel W₁₁ of the first pixel of the first row and the second sub-pixel W₁₄ of the fourth pixel of the first row emit light.

In addition, when the gate signal is applied via the third gate line G3, the second sub-pixel W₁₂ of the second pixel of the first row and the second sub-pixel W₂₃ of the third pixel of the second row emit light, and when the gate signal is applied via the fourth gate line G4, the second sub-pixel W₂₁ of the first pixel of the second row and the second sub-pixel W₂₄ of the fourth pixel of the second row emit light.

When the gate signal is applied via the fifth gate line G5, the second sub-pixel W₂₂ of the second pixel of the second row and the second sub-pixel W₂₅ of the fifth pixel of the second row emit light.

For example, sequentially applying a gate signal to the five gate lines G1-G5 illuminates specific pairs of white (W) sub-pixels. The activation sequence is as follows: G1 activates W₁₃ and W₁₅, G2 activates W₁₁ and W₁₄, G3 activates W₁₂ and W₂₃, G4 activates W₂₁ and W₂₄, and G5 activates W₂₂ and W₂₅.

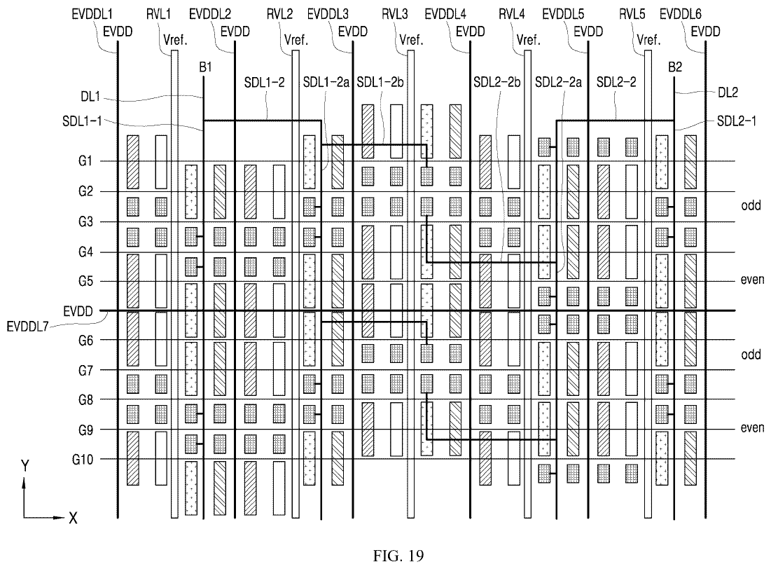

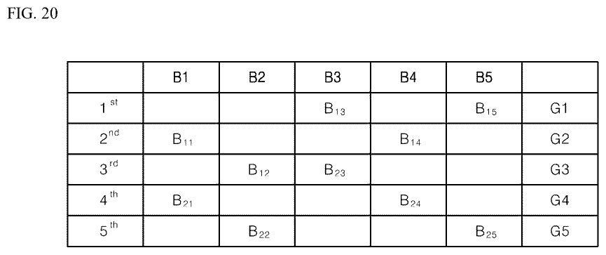

FIG. 19 is an example diagram illustrating a state in which each of a first data line and a second data line divides into a plurality of sub-data lines and each of the sub-data lines is connected to a third sub-pixel (e.g., the blue sub-pixels) of each pixel in a display panel according to an embodiment of the present disclosure. FIG. 20 is an example diagram illustrating a driving scheme of a third sub-pixel (e.g., the blue sub-pixels) using the plurality of sub-data lines into which each of the first data line and the second data line divides according to FIG. 19.

In FIG. 19, the arrangement of the pixels PX, the arrangement of the sub-pixels, the arrangement of the light-emitting area and the driving circuit of each sub-pixel, and the arrangement of the reference voltage lines RVL, the high potential voltage lines, and the additional high potential voltage line are respectively the same as the arrangement of the pixels PX, the arrangement of the sub-pixels, the arrangement of the light-emitting area and the driving circuit of each sub-pixel, and the arrangement of the reference voltage lines RVL, the high potential voltage lines, and the additional high potential voltage line in FIG. 14. Therefore, in FIG. 19, a description of each of the arrangement of the pixels PX, the arrangement of the sub-pixels, the arrangement of the light-emitting area and the driving circuit of each sub-pixel, and the arrangement of the reference voltage lines RVL, the high potential voltage lines, and the additional high potential voltage line will be omitted.

Referring to FIG. 19, the display panel 110 can drive each of the third sub-pixel B₁₁ of the first pixel, the third sub-pixel B₁₂ of the second pixel, the third sub-pixel B₁₃ of the third pixel, the third sub-pixel B₁₄ of the fourth pixel, and the third sub-pixel B₁₅ of the fifth pixel disposed in the first row, and the third sub-pixel B₂₁ of the second pixel, the third sub-pixel B₂₂ of the second pixel, the third sub-pixel B₂₃ of the third pixel, the third sub-pixel B₂₄ of the fourth pixel, and the third sub-pixel B₂₅ disposed in the second row.

To this end, the first data line DL1 divides into two sub-data lines SDL1-1 and SDL1-2, and the second sub-data line SDL1-2 divides into two sub-data lines SDL1-2a and SDL1-2b. As such, the first data line DL1 divides into three sub-data lines SDL1-1, SDL1-2a, and SDL1-2b.

In addition, the second data line DL2 divides into two sub-data lines SDL2-1 and SDL2-2, and the first sub-data line SDL2-2 divides into two sub-data lines SDL2-2a and SDL2-2b again. As such, the first data line DL2 divides into three sub-data lines SDL2-1, SDL2-2a, and SDL2-2b.

According to an embodiment, the sub-data line SDL1-1 in which the first data line DL1 divides is connected to the driving circuit of the third sub-pixel B₁₁ of the first pixel disposed in the first row and the driving circuit of the third sub-pixel B₂₁ of the first pixel disposed in the second row to drive the light-emitting area of each thereof. Further, the sub-data line SDL1-2a in which the first data line DL1 divides is connected to the driving circuit of the third sub-pixel B₁₂ of the second pixel disposed in the first row and the driving circuit of the third sub-pixel B₂₂ of the second pixel disposed in the second row to drive the light-emitting area of each thereof. In addition, the sub-data line SDL1-2b in which the first data line DL1 divides is connected to the driving circuit of the third sub-pixel B₁₃ of the third pixel disposed in the first row to drive the light-emitting area thereof.

In addition, the sub-data line SDL2-1 in which the second data line DL2 divides is connected to the driving circuit of the third sub-pixel B₁₅ of the fifth pixel disposed in the first row and the third sub-pixel B₂₅ of the fifth pixel disposed in the second row to drive the light-emitting area of each thereof. Further, the sub-data line SDL2-2a in which the second data line DL2 divides is connected to the driving circuit of the third sub-pixel B₁₄ of the fourth pixel disposed in the first row and the driving circuit of the third sub-pixel B₂₄ of the fourth pixel disposed in the second row to drive the light-emitting area of each thereof. In addition, the sub-data line SDL2-2b in which the second data line DL2 divides is connected to the driving circuit of the third sub-pixel B₂₃ of the third pixel disposed in the second row to drive the light-emitting area thereof.

For example, referring to FIG. 19, the panel drives the blue (B) sub-pixels using the same two-line, five-column architecture. Each of the two data lines (DL1, DL2) asymmetrically branches into three sub-data lines or two sub-data lines depending on which row. The branches from the first data line DL1 are coupled to the blue B sub-pixels in the first two columns and the first-row sub-pixel of the third column. Correspondingly, the branches from the second data line DL2 are coupled to the blue B sub-pixels in the fourth and fifth columns and the second-row sub-pixel of the third column, allowing the two main data lines to share/alternate control of the central column (e.g., third column).

As described above, each of the sub-data lines SDL is connected to the driving circuit of each of the sub-pixels emitting light of the same color arranged in one row to apply the data voltage to the driving circuit.

According to an embodiment, the arrangement structure of the sub-data lines respectively connected to the sub-pixels disposed in the first row and the sub-pixels disposed in the second row as described above is equally applied to the arrangement structure of the sub-data lines respectively connected to the sub-pixels disposed in the third row and the fourth row disposed on the other (on the lower side in the drawing) of both opposing side in the column direction of the second row.

According to an embodiment, the additional high potential voltage line EVDDL7 can be disposed between the second row and the third row to equalize the aperture ratio of the pixels. The additional high potential voltage line EVDDL7 extends in a parallel manner to the plurality of gate lines GL, and a single additional high potential voltage line EVDDL7 is disposed every five gate lines among the plurality of gate lines GL.

Since the positions of the gate lines GL illustrated in FIG. 19 are the same as those of FIG. 15, a description thereof will be omitted.

For example, when the gate signal is applied via the first gate line G1, the third sub-pixel B₁₃ of the third pixel of the first row and the third sub-pixel B₁₅ of the fifth pixel disposed in the first row emit light.

For example, when the gate signal is applied via the second gate line G2, the third sub-pixel B₁₁ of the first pixel disposed in the first row and the third sub-pixel B₁₄ of the fourth pixel disposed in the first row emit light.

For example, when the gate signal is applied via the third gate line G3, the third sub-pixel B₁₂ of the second pixel disposed in the first row and the third sub-pixel B₂₃ of the third pixel disposed in the second row emit light.

For example, when the gate signal is applied via the fourth gate line G4, the third sub-pixel B₂₁ of the first pixel disposed in the second row and the third sub-pixel B₂₄ of the fourth pixel disposed in the second row emit light.

For example, when the gate signal is applied via the fifth gate line G5, the third sub-pixel B₂₂ of the second pixel disposed in the second row and the third sub-pixel B₂₅ of the fifth pixel disposed in the second row emit light.

Accordingly, when the gate signal is applied via the first gate line G1, the third sub-pixel B₁₃ of the third pixel of the first row and the third sub-pixel B₁₅ of the fifth pixel of the first row emit light. When the gate signal is applied via the second gate line G2, the third sub-pixel B₁₁ of the first pixel of the first row and the third sub-pixel B₁₄ of the fourth pixel of the first row emit light.

In addition, when the gate signal is applied via the third gate line G3, the third sub-pixel B₁₂ of the first pixel in the first row and the third sub-pixel B₂₃ of the third pixel in the second row emit light. When the gate signal is applied via the fourth gate line G4, the third sub-pixel B₂₁ of the first pixel in the second row and the third sub-pixel B₂₄ of the fifth pixel in the second row emit light.

When the gate signal is applied via the fifth gate line G5, the third sub-pixel B₂₂ of the second pixel in the second row and the third sub-pixel B₂₅ of the fifth pixel in the second row emit light.

For example, sequentially applying a gate signal to the five gate lines G1-G5 illuminates specific pairs of blue (B) sub-pixels. The activation sequence is as follows: G1 activates B₁₃ and B₁₅, G2 activates B₁₁ and B₁₄, G3 activates B₁₂ and B₂₃, G4 activates B₂₁ and B₂₄, and G5 activates B₂₂ and B₂₅.

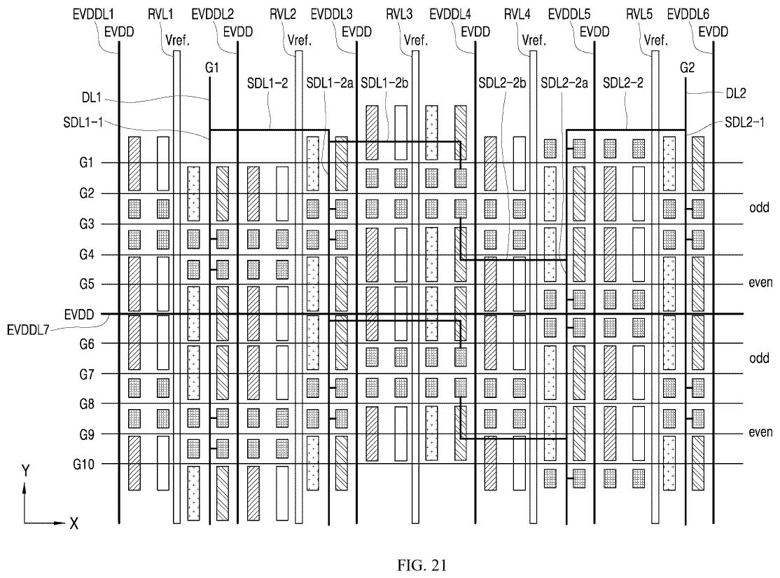

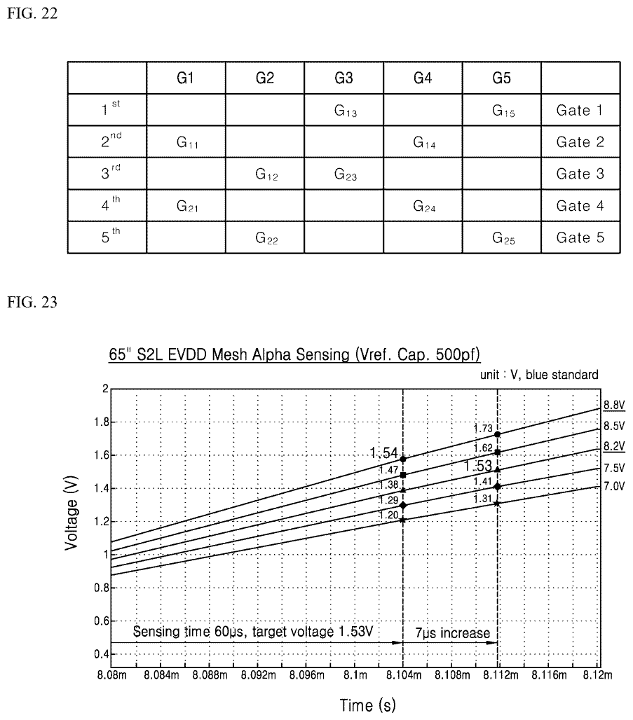

FIG. 21 is an example diagram illustrating a state in which each of a first data line and a second data line divides into a plurality of sub-data lines and each of the sub-data lines is connected to a fourth sub-pixel (e.g., the green sub-pixels) of each pixel in a display panel according to an embodiment of the present disclosure. FIG. 22 is an example diagram illustrating a driving scheme of a fourth sub-pixel (e.g., the green sub-pixels) using the plurality of sub-data lines into which each of the first data line and the second data line divides according to FIG. 21.

In FIG. 21, the arrangement of the pixels PX, the arrangement of the sub-pixels, the arrangement of the light-emitting area and the driving circuit of each sub-pixel, and the arrangement of the reference voltage lines RVL, the high potential voltage lines, and the additional high potential voltage line are respectively the same as the arrangement of the pixels PX, the arrangement of the sub-pixels, the arrangement of the light-emitting area and the driving circuit of each sub-pixel, and the arrangement of the reference voltage lines RVL, the high potential voltage lines, and the additional high potential voltage line in FIG. 14. Therefore, in FIG. 21, a description of each of the arrangement of the pixels PX, the arrangement of the sub-pixels, the arrangement of the light-emitting area and the driving circuit of each sub-pixel, and the arrangement of the reference voltage lines RVL, the high potential voltage lines, and the additional high potential voltage line will be omitted.

Referring to FIG. 21, the display panel 110 can drive each of the fourth sub-pixel G₁₁ of the first pixel, the fourth sub-pixel G₁₂ of the second pixel, the fourth sub-pixel G₁₃ of the third pixel, the fourth sub-pixel G₁₄ of the fourth pixel, and the fourth sub-pixel G₁₅ of the fifth pixel disposed in the first row, and regarding the second row, the fourth sub-pixel G₂₁ of the first pixel, the fourth sub-pixel G₂₂ of the second pixel, the fourth sub-pixel G₂₃ of the third pixel, the fourth sub-pixel G₂₄ of the fourth pixel, and the fourth sub-pixel G₂₅ disposed in the second row.

To this end, the first data line DL1 divides into two sub-data lines SDL1-1 and SDL1-2, and the second sub-data line SDL1-2 divides into two sub-data lines SDL1-2a and SDL1-2b. As such, the first data line DL1 divides into three sub-data lines SDL1-1, SDL1-2a, and SDL1-2b.

In addition, the second data line DL2 divides into two sub-data lines SDL2-1 and SDL2-2, and the first sub-data line SDL2-2 divides into two sub-data lines SDL2-2a and SDL2-2b again. As such, the first data line DL2 divides into three sub-data lines SDL2-1, SDL2-2a, and SDL2-2b.

According to an embodiment, the sub-data line SDL1-1 in which the first data line DL1 divides is connected to the driving circuit of the fourth sub-pixel G₁₁ of the first pixel disposed in the first row and the driving circuit of the fourth sub-pixel G₂₁ of the first pixel disposed in the second row to drive the light-emitting area of each thereof. Further, the sub-data line SDL1-2a in which the first data line DL1 divides is connected to the driving circuit of the fourth sub-pixel G₁₂ of the second pixel disposed in the first row and the driving circuit of the fourth sub-pixel G₂₂ of the second pixel disposed in the second row to drive the light-emitting area of each thereof. In addition, the sub-data line SDL1-2b in which the first data line DL1 divides is connected to the driving circuit of the fourth sub-pixel G₁₃ of the third pixel disposed in the first row to drive the light-emitting area thereof.

In addition, the sub-data line SDL2-1 in which the second data line DL2 divides is connected to the driving circuit of the fourth sub-pixel G₁₅ of the fifth pixel disposed in the first row and the fourth sub-pixel G₂₅ of the fifth pixel disposed in the second row to drive the light-emitting area of each thereof. Further, the sub-data line SDL2-2a in which the second data line DL2 divides is connected to the driving circuit of the fourth sub-pixel G14 of the fourth pixel disposed in the first row and the driving circuit of the fourth sub-pixel G₂₄ of the fourth pixel disposed in the second row to drive the light-emitting area of each thereof. The sub-data line SDL2-2b in which the second data line DL2 divides is connected to the driving circuit of the fourth sub-pixel G₂₃ of the third pixel disposed in the second row to drive the light-emitting area thereof.

As described above, each of the sub-data lines SDL is connected to the driving circuit of each of the sub-pixels emitting light of the same color arranged in one row to apply the data voltage to the driving circuit.

According to an embodiment, the arrangement structure of the sub-data lines respectively connected to the sub-pixels disposed in the first row and the sub-pixels disposed in the second row as described above is equally applied to the arrangement structure of the sub-data lines respectively connected to the sub-pixels disposed in the third row and the fourth row disposed on the other (on the lower side in the drawing) of both opposing side in the column direction of the second row.

According to an embodiment, the additional high potential voltage line EVDDL7 can be disposed between the second row and the third row to equalize the aperture ratio of the pixels. The additional high potential voltage line EVDDL7 extends in a parallel manner to the plurality of gate lines GL, and a single additional high potential voltage line EVDDL7 is disposed every five gate lines among the plurality of gate lines GL.

Since the positions of the gate lines GL illustrated in FIG. 21 are the same as those of FIG. 15, descriptions thereof will be omitted.

For example, when the gate signal is applied via the first gate line G1, the fourth sub-pixel G₁₃ of the third pixel disposed in the first row and the fourth sub-pixel G₁₅ of the fifth pixel in the first row emit light.

For example, when the gate signal is applied via the second gate line G2, the fourth sub-pixel G₁₁ of the first pixel disposed in the first row and the fourth sub-pixel G₁₄ of the fourth pixel in the first row emit light.

For example, when the gate signal is applied via the third gate line G3, the fourth sub-pixel G₁₂ of the second pixel disposed in the first row and the fourth sub-pixel G₂₃ of the third pixel disposed in the second row emit light.

For example, when the gate signal is applied via the fourth gate line G4, the fourth sub-pixel G₂₁ of the first pixel disposed in the second row and the fourth sub-pixel G₂₄ of the fourth pixel disposed in the second row emit light.

For example, when the gate signal is applied via the fifth gate line G5, the fourth sub-pixel G₂₂ of the second pixel disposed in the second row and the fourth sub-pixel B₂₅ of the fifth pixel disposed in the second row emit light.

Accordingly, when the gate signal is applied via the first gate line G1, the fourth sub-pixel G₁₃ of the third pixel in the first row and the fourth sub-pixel G₁₅ of the fifth pixel in the first row emit light. When the gate signal is applied via the second gate line G2, the fourth sub-pixel G₁₁ of the first pixel in the first row and the fourth sub-pixel G₁₄ of the forth pixel in the first row emit light.

In addition, when the gate signal is applied via the third gate line G3, the fourth sub-pixel G₁₂ of the second pixel of the first row and the fourth sub-pixel G₂₃ of the third pixel of the second row emit light. When the gate signal is applied via the fourth gate line G4, the fourth sub-pixel G₂₁ of the first pixel of the second row and the fourth sub-pixel G₂₄ of the fourth pixel of the second row emit light.

When the gate signal is applied via the fifth gate line G5, the fourth sub-pixel G₂₂ of the second pixel in the second row and the fourth sub-pixel G₂₅ of the fifth pixel in the second row emit light.

In other words, sequentially applying a gate signal to the five gate lines G1-G5 illuminates specific pairs of green (G) sub-pixels. The activation sequence is as follows: G1 activates G₁₃ and G₁₅, G2 activates G₁₁ and G₁₄, G3 activates G₁₂ and G₂₃, G4 activates G₂₁ and G₂₄, and G5 activates G₂₂ and G₂₅.

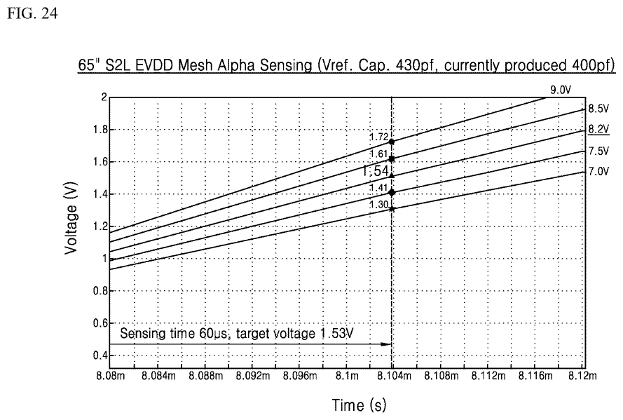

FIG. 23 is a result showing sensing characteristics based on a reference voltage in a related art example. FIG. 24 is a result showing sensing characteristics based on a reference voltage according to an embodiment of the present disclosure.

Referring to FIGS. 23 and 24, in the display panel 110 according to an embodiment of the present disclosure, the reference voltage line does not divide into the sub-reference voltage lines, such that the capacitance of the reference voltage is lowered, and accordingly, a margin of the sensing voltage can be secured.

When the sensing time of the display panel 110 is 60 μs and a target voltage is 1.53V, the time taken for the voltage to increase to 1.53V in sensing the sub-pixel through the reference voltage is 8.112 μs in the related art example, whereas the time taken for the voltage to increase to 1.53V in sensing the sub-pixel through the reference voltage is 8.104 μs which is smaller than 8.112 μs in the related art example by 0.08 μs in the display panel 110 according to the present disclosure.

As described above, in the display panel 110 according to the present disclosure, one data line divides into a plurality of sub data lines so that a data voltage is applied to each of the sub-pixels emitting light of the same color arranged in the same row via each sub-data line.

In addition, the display panel 110 according to the present disclosure can improve visibility by applying the data voltage to each of the sub-pixels emitting light of the same color arranged in the same row via each of the sub-data lines.

In addition, in the display panel 110 according to the present disclosure, the additional high-potential voltage line is disposed every five gate lines and extends in a direction perpendicular to the extension direction of the plurality of high-potential voltage lines such that the additional high-potential voltage lines and the plurality of high-potential voltage lines intersect each other to form the mesh structure, thereby making it possible to equalize the aperture ratio.

According to an embodiment of the present disclosure, the display panel can include a plurality of pixels including, each a plurality of sub-pixels emitting light of different colors, a plurality of data lines supplying a data voltage to the plurality of pixels, and a plurality of gate lines supplying a gate signal to the plurality of pixels.

According to an embodiment, each of the plurality of data lines can divide into a plurality of sub-data lines, and each of the plurality of sub-data lines can apply the data voltage to each of the sub-pixels emitting light of the same color arranged in the same row.

According to an embodiment, each of the plurality of data lines can divide into three sub-data lines such that the data voltage is applied to each of three sub-pixels emitting light of the same color arranged in the first row via each of the three sub-data lines. Alternatively, each of the plurality of data lines can divide into two sub-data lines such that the data voltage is applied to each of two sub-pixels emitting light of the same color arranged in the first row via each of the two sub-data lines.

According to an embodiment, the plurality of data lines include a first data line and a second data line arranged in a row direction and extending in a column direction, in which the first data line divides into three sub-data lines such that the data voltage is applied to three sub-pixels emitting light of the same color arranged in the first row via each of the three sub-data lines, in which the second data line divides into two sub-data lines such that the data voltage is applied to two sub-pixels emitting light of the same color arranged in the first row via each of the two sub-data lines.

According to an embodiment, the plurality of data lines include a first data line and a second data line arranged in a row direction and extending in a column direction, in which the first data line divides into two sub-data lines such that the data voltage is applied to two sub-pixels emitting light of the same color arranged in the first row via each of the two sub-data lines, in which the second data line divides into three sub-data lines such that the data voltage is applied to three sub-pixels emitting light of the same color arranged in the first row via each of the three sub-data lines.

According to an embodiment, a first data line of the plurality of data lines divides into three sub-data lines such that the data voltage is applied to each of three sub-pixels emitting light of the same color arranged in the first row via each of the three sub-data lines, in which the three sub-data lines include a first sub-data line to a third sub-data line arranged in a row direction, in which the pixels include a first pixel to a fifth pixel arranged in the row direction, and the sub-pixels of each of the first pixel to the fifth pixel include a first sub-pixel to a fourth sub-pixel arranged in the row direction, in which the first sub-data line applies the data voltage to the first sub-pixel of the first pixel, the second sub-data line applies the data voltage to the first sub-pixel of the second pixel adjacent to the first pixel, and the third sub-data line applies the data voltage to the first sub-pixel of the third pixel adjacent to the second pixel.

According to an embodiment, a second data line of the plurality of data lines divides into two sub-data lines such that the data voltage is applied to each of two sub-pixels emitting light of the same color arranged in the first row via each of the two sub-data lines, in which the two sub-data lines include fourth and fifth sub-data lines arranged in the row direction, in which the fourth sub-data line applies the data voltage to the first sub-pixel of the fourth pixel adjacent to the third pixel, in which the fifth sub-data line applies the data voltage to the first sub-pixel of the fifth pixel adjacent to the fourth pixel.

According to an embodiment, a first data line of the plurality of data lines divides into two sub-data lines such that the data voltage is applied to each of two sub-pixels emitting light of the same color arranged in the first row via each of the two sub-data lines, in which the two sub-data lines include first and second sub-data lines arranged in a row direction, in which the pixels include a first pixel to a fifth pixel arranged in the row direction, and the sub-pixels of each of the first pixel to the fifth pixel include a first sub-pixel to a fourth sub-pixel arranged in the row direction, in which the first sub-data line applies the data voltage to the first sub-pixel of the first pixel, in which the second sub-data line applies the data voltage to the first sub-pixel of the second pixel adjacent to the first pixel.

According to an embodiment, a second data line of the plurality of data lines divides into three sub-data lines such that the data voltage is applied to each of three sub-pixels emitting light of the same color arranged in the first row via each of the three sub-data lines, in which the three sub-data lines include third and fifth sub-data lines arranged in the row direction, in which the third sub-data line applies the data voltage to the first sub-pixel of the third pixel adjacent to the second pixel, in which the fourth sub-data line applies the data voltage to the first sub-pixel of the fourth pixel adjacent to the third pixel, in which the fifth sub-data line applies the data voltage to the first sub-pixel of the fifth pixel adjacent to the fourth pixel.

According to an embodiment, each of the first sub-pixel of the first pixel and the first sub-pixel of the second pixel receives the data voltage via each of the first sub-data line and the second sub-data line into which the first data line among the plurality of data lines divides, in which the first sub-pixel of the third pixel receives the data voltage via the third sub-data line into which the first data line divides, in which each of the first sub-pixel of the fourth pixel and the first sub-pixel of the fifth pixel receives the data voltage via each of the fourth sub-data line and the fifth sub-data line into which the second data line among the plurality of data lines divides.

According to an embodiment, the display panel further comprises a plurality of high potential voltage lines, each of the plurality of high potential voltage lines being disposed between adjacent pixels, in which the high potential voltage line extends in the column direction of the display panel, and each of the plurality of high potential voltage lines supplies a high potential voltage to the sub-pixels of each of the plurality of pixels.

According to an embodiment, the display panel further comprises an additional high-potential voltage line extending in the row direction.

According to an embodiment, a single additional high potential voltage line is disposed every five gate lines among the plurality of gate lines, in which the additional high potential voltage line extends in a parallel manner to the plurality of gate lines, and the plurality of high potential voltage lines and the additional high potential voltage lines intersect each other to form a mesh structure.

According to an embodiment, the plurality of pixels include a first pixel to a fifth pixel sequentially arranged in the row direction, and the sub-pixels of each of the first pixel to the fifth pixel include a first sub-pixel to a fourth sub-pixel sequentially arranged in the row direction, in which each of the sub-pixels includes a light-emitting area and a driving circuit for driving the light-emitting area, in each of the sub-pixels of each of the first pixel to the third pixel arranged in a first row, the driving circuit is disposed on the other of both opposing side in the column direction of the light-emitting area, and in each of some of the sub-pixels of each of the fourth pixel and the fifth pixel arranged in the first row, the driving circuit is disposed on the other of both opposing side in the column direction of the light-emitting area, while in each of the others of the sub-pixels of each of the fourth pixel and the fifth pixel arranged in the first row, the driving circuit is disposed on one of both opposing side in the column direction of the light-emitting area.

According to an embodiment, in each of the sub-pixels of each of the first pixel to the third pixel arranged in a second row, the driving circuit is disposed on one of both opposing side in the column direction of the light-emitting area.

According to an embodiment, in each of some of the sub-pixels of each of the fourth pixel and the fifth pixel arranged in the first row, the driving circuit is disposed on one of both opposing side in the column direction of the light-emitting area, while in each of the others of the sub-pixels of each of the fourth pixel and the fifth pixel arranged in the first row, the driving circuit is disposed on the other of both opposing side in the column direction of the light-emitting area.

According to an embodiment, an arrangement of the light-emitting area and the driving circuit of each of the sub-pixels of each of a plurality of pixels disposed in each of the first row and the second row are repeated every two rows.

According to an embodiment, the plurality of gate lines include a first gate line to a fifth gate line extending in the row direction and arranged in the column direction, in which the first gate line is disposed between the light-emitting area and the driving circuit of each of the first sub-pixel to the fourth sub-pixel of the third pixel of the first row, between the driving circuit and the light-emitting area of each of the third sub-pixel and the fourth sub-pixel of the fourth pixel of the first row, and between the driving circuit and the light-emitting area of each of the first sub-pixel and the second sub-pixel of the fifth pixel of the first row.

According to an embodiment, the second gate line is disposed between the light-emitting area and the driving circuit of each of the first sub-pixel and the second sub-pixel of the first pixel of the first row, between the driving circuit and the light-emitting area of each of the third sub-pixel and the fourth sub-pixel of the second pixel of the first row, between the driving circuit and the light-emitting area of each of the first and second sub-pixel of the fourth pixel of the first row, and between the driving circuit and the light-emitting area of each of the third sub-pixel and the fourth sub-pixel of the fifth pixel of the first row.

According to an embodiment, the third gate line is disposed between the light-emitting area and the driving circuit of each of the third sub-pixel and the fourth sub-pixel of the first pixel of the first row, between the driving circuit and the light-emitting area of each of the first sub-pixel and the second sub-pixel of the second pixel of the first row, and between the driving circuit and the light-emitting area of each of the first sub-pixel to the fourth sub-pixel of the third pixel of the second row.

According to an embodiment, the fourth gate line is disposed between the light-emitting area and the driving circuit of each of the first sub-pixel and the second sub-pixel of the first pixel of the second row, between the driving circuit and the light-emitting area of each of the third sub-pixel and the fourth sub-pixel of the second pixel of the second row, between the driving circuit and the light-emitting area of each of the first sub-pixel and the second sub-pixel of the fourth pixel of the second row, and between the driving circuit and the light-emitting area of each of the third sub-pixel and the fourth sub-pixel of the fifth pixel of the second row.

According to an embodiment, the fifth gate line is disposed between the light-emitting area and the driving circuit of each of the third sub-pixel and the fourth sub-pixel of the first pixel of the second row, between the driving circuit and the light-emitting area of each of the first sub-pixel and the second sub-pixel of the second pixel of the second row, between the driving circuit and the light-emitting area of each of the third sub-pixel and the fourth sub-pixel of the fourth pixel of the second row, and between the driving circuit and the light-emitting area of each of the first sub-pixel and the second sub-pixel of the fifth pixel of the second row.

According to an embodiment, a display device includes: a display panel including a plurality of pixels, each of the plurality pixels including a plurality of sub-pixels respectively emitting light of different colors; a data driver configured to supply a data voltage to the plurality of pixels via a plurality of data lines; and a gate driver configured to supply a gate signal to the plurality of pixels via a plurality of gate lines, in which the display panel is configured to drive five pixels arranged in the same row using two data lines, in which the display panel includes: the plurality of pixels; the plurality of data lines disposed to supply the data voltage to the plurality of pixels; and the plurality of gate lines disposed to supply the gate signal to the plurality of pixels, in which each of the plurality of data lines divides into a plurality of sub-data lines, in which the data voltage is applied to each of the sub-pixels emitting light of the same color arranged in the same row via each of the plurality of sub-data lines.

Although some embodiments of the present disclosure have been described above with reference to the accompanying drawings, the present disclosure may not be limited to some embodiments and can be implemented in various different forms. Those of ordinary skill in the technical field to which the present disclosure belongs will be able to appreciate that the present disclosure can be implemented in other specific forms without changing the technical idea or essential features of the present disclosure. Therefore, it should be understood that some embodiments as described above are not restrictive but illustrative in all respects.

What is claimed is:

1. A display panel, comprising:
a plurality of pixels, each of the plurality of pixels including a plurality of sub-pixels configured to emit light of different colors;
a plurality of data lines configured to supply a data voltage to the plurality of pixels; and
a plurality of gate lines configured to supply a gate signal to the plurality of pixels,
wherein each of the plurality of data lines divides into a plurality of bridge data lines, and
wherein a group of five sub-pixels among the plurality of pixels arranged in a same row are configured to be driven by two data lines among the plurality of data lines and emit light of a same color.

2. The display panel of claim 1, wherein each of the plurality of data lines divides into three bridge data lines such that the data voltage is applied to each of three sub-pixels configured to emit light of the same color arranged in a first row via the three bride data lines, or
wherein each of the plurality of data lines divides into two bridge data lines such that the data voltage is applied to each of two sub-pixels configured to emit light of the same color arranged in the first row via the two bridge data lines.

3. The display panel of claim 2, wherein the plurality of data lines include a first data line and a second data line arranged in a row direction and extending in a column direction,
wherein the first data line divides into three bridge data lines such that the data voltage is applied to three sub-pixels configured to emit light of the same color arranged in the first row via the three bridge data lines, and
wherein the second data line divides into two bridge data lines such that the data voltage is applied to two sub-pixels configured to emit light of the same color arranged in the first row via the two bridge data lines.

4. The display panel of claim 2, wherein the plurality of data lines include a first data line and a second data line arranged in a row direction and extending in a column direction,
wherein the first data line divides into two bridge data lines such that the data voltage is applied to two sub-pixels configured to emit light of the same color arranged in the first row via each of the two bridge data lines, and
wherein the second data line divides into three bridge data lines such that the data voltage is applied to three sub-pixels configured to emit light of the same color arranged in the first row via each of the three bridge data lines.

5. The display panel of claim 2, wherein a first data line of the plurality of data lines divides into three bridge data lines such that the data voltage is applied to each of three sub-pixels configured to emit light of the same color arranged in the first row via the three bridge data lines,
wherein the three bridge data lines of the first data line include a first bridge data line, a second bridge data line and a third bridge data line arranged in a row direction,
wherein the plurality of pixels include a first pixel, a second pixel, a third pixel, a fourth pixel and a fifth pixel arranged in the row direction, and each of the first, second, third, fourth and fifth pixels includes a first sub-pixel, a second sub-pixel, a third sub-pixel and a fourth sub-pixel arranged in the row direction,
wherein the first bridge data line of the first data line is configured to apply the data voltage to the first sub-pixel of the first pixel,
wherein the second bridge data line of the first data line is configured to apply the data voltage to the first sub-pixel of the second pixel adjacent to the first pixel, and
wherein the third bridge data line of the first data line is configured to apply the data voltage to the first sub-pixel of the third pixel adjacent to the second pixel.

6. The display panel of claim 5, wherein a second data line of the plurality of data lines divides into two bridge data lines such that the data voltage is applied to each of two sub-pixels configured to emit light of the same color arranged in the first row,
wherein the two bridge lines of the second data line include a fourth bridge data line and a fifth bridge data line arranged in the row direction,
wherein the fourth bridge data line is configured to apply the data voltage to the first sub-pixel of the fourth pixel adjacent to the third pixel, and
wherein the fifth bridge data line is configured to apply the data voltage to the first sub-pixel of the fifth pixel adjacent to the fourth pixel.

7. The display panel of claim 6, wherein the first sub-pixel of the first pixel and the first sub-pixel of the second pixel are configured to respectively receive the data voltage via the first bridge data line and the second bridge data line of the first data line,
wherein the first sub-pixel of the third pixel is configured to receive the data voltage via the third bridge data line of the first data line, and
wherein the first sub-pixel of the fourth pixel and the first sub-pixel of the fifth pixel are configured to respectively receive the data voltage via the fourth bridge data line and the fifth bridge data line of the second data line.

8. The display panel of claim 2, wherein a first data line of the plurality of data lines divides into two bridge data lines such that the data voltage is applied to each of two sub-pixels configured to emit light of the same color arranged in the first row,
wherein the two bridge data lines of the first data line include a first bridge data line and a second bridge data line arranged in a row direction,
wherein the pixels include a first pixel, a second pixel, a third pixel, a fourth pixel and a fifth pixel arranged in the row direction, and each of the first, second, third, fourth and fifth pixels include a first sub-pixel, a second sub-pixel, a third sub-pixel and a fourth sub-pixel arranged in the row direction,
wherein the first bridge data line of the first data line is configured to apply the data voltage to the first sub-pixel of the first pixel, and
wherein the second bridge data line of the first data line is configured to apply the data voltage to the first sub-pixel of the second pixel adjacent to the first pixel.

9. The display panel of claim 8, wherein a second data line of the plurality of data lines divides into three bridge data lines such that the data voltage is applied to each of three sub-pixels configured to emit light of the same color arranged in the first row,
wherein the three bridge data lines of the second data line include a third bridge data line, a fourth bridge data line and a fifth bridge data line arranged in the row direction,
wherein the third bridge data line of the second data line is configured to apply the data voltage to the first sub-pixel of the third pixel adjacent to the second pixel,
wherein the fourth bridge data line of the second data line is configured to apply the data voltage to the first sub-pixel of the fourth pixel adjacent to the third pixel, and
wherein the fifth bridge data line of the second data line is configured to apply the data voltage to the first sub-pixel of the fifth pixel adjacent to the fourth pixel.

10. The display panel of claim 1, further comprising:
a plurality of high potential voltage lines, each of the plurality of high potential voltage lines being disposed between adjacent pixels among the plurality of pixels,
wherein each of the plurality of high potential voltage lines extends in a column direction of the display panel, and
wherein the plurality of high potential voltage lines are configured to supply a high potential voltage to the plurality of sub-pixels of the plurality of pixels.

11. The display panel of claim 10, further comprising an additional high-potential voltage line extending in a row direction.

12. The display panel of claim 11, wherein a single additional high potential voltage line is disposed every five gate lines among the plurality of gate lines,
wherein the single additional high potential voltage line extends parallel to the plurality of gate lines, and
wherein the plurality of high potential voltage lines and the single additional high potential voltage line intersect to form a mesh structure.

13. The display panel of claim 1, wherein the plurality of pixels include a first pixel, a second pixel, a third pixel, a fourth pixel and a fifth pixel sequentially arranged in a row direction, and each of the first, second, third, fourth and fifth pixels includes a first sub-pixel, a second sub-pixel, a third sub-pixel and a fourth sub-pixel sequentially arranged in the row direction,
wherein each of the first, second, third, and fourth sub-pixels in the first, second, third, fourth and fifth pixels includes a light-emitting area and a driving circuit for driving the light-emitting area,
wherein in each of the first, second, third, and fourth sub-pixels of each of the first pixel, the second pixel and the third pixel are arranged in a first row, and the driving circuits of the first, second, third, and fourth sub-pixels of each of the first pixel, the second pixel and the third pixel are disposed on a same side of the light-emitting area in a column direction, and
wherein the first, second, third, and fourth sub-pixels of each of the fourth pixel and the fifth pixel are arranged in the first row and have some driving circuits disposed one side of the light-emitting areas in the column direction and other driving circuits disposed on another side of the light-emitting areas in the column direction.

14. The display panel of claim 13, wherein first, second, third, and fourth sub-pixels of each of the first, second and third pixels arranged in a second row have driving circuits disposed on a same side in the column direction of the light-emitting areas, and
wherein first, second, third, and fourth sub-pixels of a fourth pixel and a fifth pixel arranged in the second row have some driving circuits disposed one side of the light-emitting areas in the column direction and other driving circuits disposed on another side of the light-emitting areas in the column direction.

15. The display panel of claim 14, wherein an arrangement of the light-emitting areas and the driving circuits of sub-pixels in a plurality of pixels disposed in the first row and the second row is repeated every two rows.

16. The display panel of claim 14, wherein the plurality of gate lines include a first gate line, a second gate line, a third gate line, a fourth gate line and a fifth gate line extending in the row direction and arranged in the column direction,
wherein the first gate line is disposed between the light-emitting area and the driving circuit of each of the first, second, third and fourth sub-pixels of the third pixel of the first row, between the driving circuit and the light-emitting area of each of the third sub-pixel and the fourth sub-pixel of the fourth pixel of the first row, and between the driving circuit and the light-emitting area of each of the first sub-pixel and the second sub-pixel of the fifth pixel of the first row,
wherein the second gate line is disposed between the light-emitting area and the driving circuit of each of the first sub-pixel and the second sub-pixel of the first pixel of the first row, between the driving circuit and the light-emitting area of each of the third sub-pixel and the fourth sub-pixel of the second pixel of the first row, between the driving circuit and the light-emitting area of each of the first sub-pixel and the second sub-pixel of the fourth pixel of the first row, and between the driving circuit and the light-emitting area of each of the third sub-pixel and the fourth sub-pixel of the fifth pixel of the first row, and
wherein the third gate line is disposed between the light-emitting area and the driving circuit of each of the third sub-pixel and the fourth sub-pixel of the first pixel of the first row, between the driving circuit and the light-emitting area of each of the first sub-pixel and the second sub-pixel of the second pixel of the first row, and between the driving circuit and the light-emitting area of each of the first sub-pixel to the fourth sub-pixel of the third pixel of the second row.

17. The display panel of claim 16, wherein the fourth gate line is disposed between the light-emitting area and the driving circuit of each of the first sub-pixel and the second sub-pixel of the first pixel of the second row, between the driving circuit and the light-emitting area of each of the third sub-pixel and the fourth sub-pixel of the second pixel of the second row, between the driving circuit and the light-emitting area of each of the first sub-pixel and the second sub-pixel of the fourth pixel of the second row, and between the driving circuit and the light-emitting area of each of the third sub-pixel and the fourth sub-pixel of the fifth pixel of the second row, and
wherein the fifth gate line is disposed between the light-emitting area and the driving circuit of each of the third sub-pixel and the fourth sub-pixel of the first pixel of the second row, between the driving circuit and the light-emitting area of each of the first sub-pixel and the second sub-pixel of the second pixel of the second row, between the driving circuit and the light-emitting area of each of the third sub-pixel and the fourth sub-pixel of the fourth pixel of the second row, and between the driving circuit and the light-emitting area of each of the first sub-pixel and the second sub-pixel of the fifth pixel of the second row.

18. A display panel, comprising:
a first pixel group including five pixels arranged in a first row, each of the five pixels in the first pixel group including a plurality of sub-pixels;
a first data line and a second data line associated with the first pixel group;
first, second and third bridge data lines branching from the first data line and configured to drive three sub-pixels having a same color among the five pixels of the first pixel group; and
third and fourth bridge data lines branching from the second data line and configured to drive two sub-pixels having the same color among the five pixels of the first pixel group.

19. The display panel of claim 18, further comprising:
a second pixel group including five pixels arranged in a second row, each of the five pixels in the second pixel group including a plurality of sub-pixels;
first and second bridge data lines branching from the first data line and configured to drive two sub-pixels having the same color among the five pixels of the second pixel group; and
third, fourth and fifth bridge data lines branching from the second data line and configured to drive three sub-pixels having the same color among the five pixels of the second pixel group.

20. The display panel of claim 19, wherein the plurality sub-pixels of the first pixel group and the plurality sub-pixels of the second pixel group are arranged in five columns.

21. The display panel of claim 19, further comprising a plurality of gate lines,
wherein five gate lines among the plurality of gates lines are connected to the first and second pixel groups.

22. The display panel of claim 21, wherein at least one of the five gate lines is configured to simultaneously supply a gate signal to a sub-pixel in the first row and a sub-pixel in the second row among the first and second pixel groups.

23. The display panel of claim 19, further comprising a plurality of high potential voltage lines arranged in a mesh structure that intersects with the first and second pixel groups.

24. The display panel of claim 19, wherein the five pixels in the second pixel group are arranged in a flip structure relative to the five pixels in the first pixel group.

25. The display panel of claim 18, wherein a data voltage on the first data line and the second data line remains constant for a duration of a frame when displaying a monochromatic still screen.
